(19) United States
(12) Patent Application Publication
(10) Pub. No.: US 2023/0143198 A1
(43) Pub. Date: May 11, 2023

(54) SYSTEM AND METHOD FOR VIEWSHED ANALYSIS

(71) Applicant: Cape Analytics, Inc., Palo Alto, CA (US)

(72) Inventor: Giacomo Vianello, Palo Alto, CA (US)

(21) Appl. No.: 17/981,903

(22) Filed: Nov. 7, 2022

Related U.S. Application Data
(60) Provisional application No. 63/276,407, filed on Nov. 5, 2021.

(51) Int. Cl. G06Q 50/16; G06V 20/00; G06Q 30/02

(52) U.S. Cl. CPC G06Q 50/165; G06V 20/38; G06Q 30/0278; G06V 2201/12

(57) ABSTRACT

In variants, a method for viewshed analysis can include: determining a location, determining a set of location viewpoints for the location, determining a viewshed for the location, determining a set of view factors for the location, and determining a view factor representation for the location based the viewshed and the set of view factors, optionally determining a view parameter for the location, and/or any other suitable elements.

### CROSS-REFERENCE TO RELATED APPLICATIONS

This application claims the benefit of U.S. Provisional Application No. 63/276,407 filed 5 Nov. 2021, which is incorporated in its entirety by this reference.

### TECHNICAL FIELD

This invention relates generally to the property valuation field, and more specifically to a new and useful method and system for viewshed analysis.

### BACKGROUND

It is of interest and practical importance to be able to accurately assess various aspects of a property. Assessments have implications in the fields of property valuation, risk mitigation, and planning. While many useful metrics have been developed that help predict risk levels and valuations, the view from a property remains difficult to quantify.

Thus, there is a need in the property valuation field to create a new and useful method and system for viewshed analysis.

### BRIEF DESCRIPTION OF THE FIGURES

FIG. 1 is a schematic representation of a variant of the method.

FIG. 2 is a schematic representation of a variant of the system.

FIG. 3 depicts an example of a viewshed.

FIG. 4 depicts an example of a view factor map.

FIG. 5 depicts an example of a view factor representation.

FIGS. 6A and 6B depict examples of masked view factor representations.

FIGS. 7A and 7B depict examples of view score determination.

FIGS. 8A, 8B, and 8C are a first, second, and third illustrative example of view score determination, respectively.

FIGS. 9A, 9B, and 9C are a first, second, and third illustrative examples of analysis model training, respectively.

FIG. 10 is a schematic representation of a variant of the method.

FIGS. 11A, 11B, 11C, 11D, and 11E depict illustrative examples of viewpoint determination.

FIGS. 12A and 12B depict illustrative examples of masking out a built structure segment.

### DETAILED DESCRIPTION

The following description of the embodiments of the invention is not intended to limit the invention to these embodiments, but rather to enable any person skilled in the art to make and use this invention.

### 1. Overview

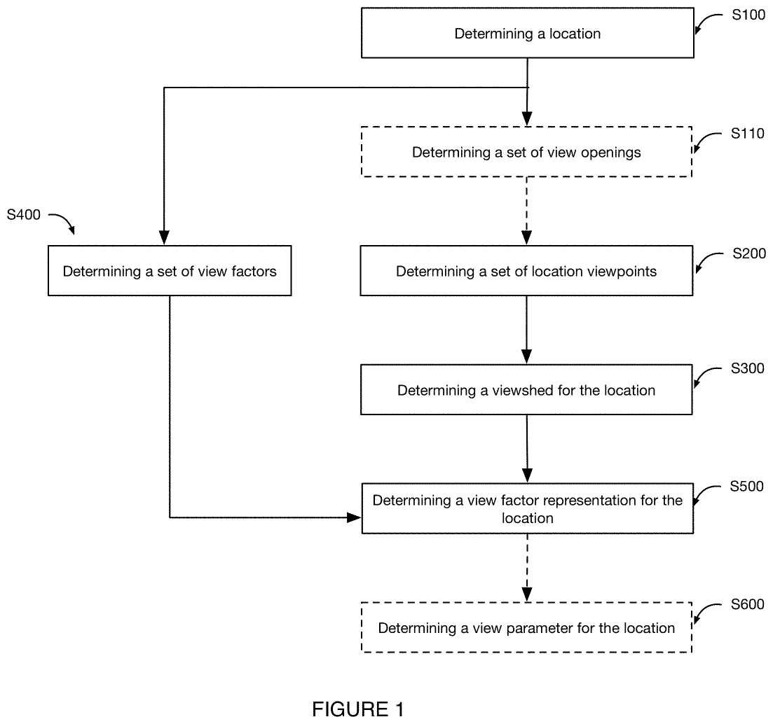

As shown in FIG. 1, in variants, a method for viewshed analysis can include: determining a location S100, determining a set of location viewpoints for the location S200, determining a viewshed for the location S300, determining a set of view factors for the location S400, and determining a view factor representation for the location based the viewshed and the set of view factors S500, optionally determining a view parameter for the location S600, and/or any other suitable elements.

The method functions to determine a quantitative and/or objective measure of a location's view (e.g., view desirability, view parameters, etc.). The resultant measure can be used in property analysis methods, such as to predict market value, determine model prediction errors, determine valuation corrections, determine population-level comparisons (e.g., property comparison against its neighbors, neighborhood comparisons with other neighborhoods, etc.), and/or otherwise used.

### 2. Examples

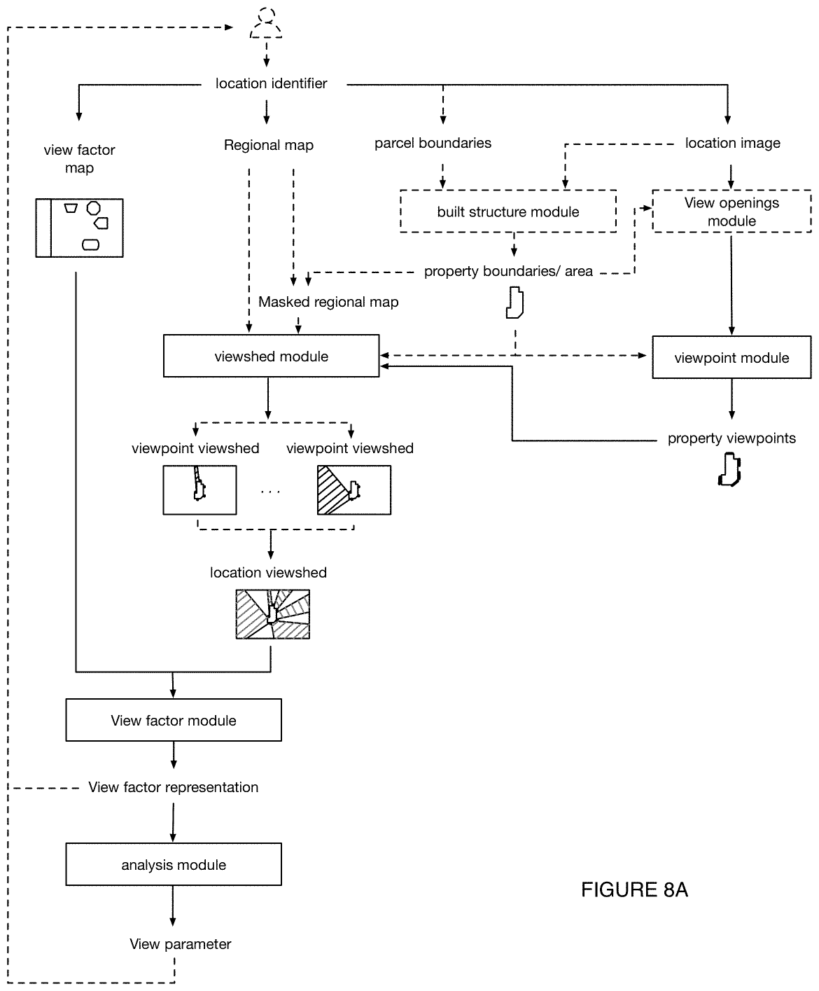

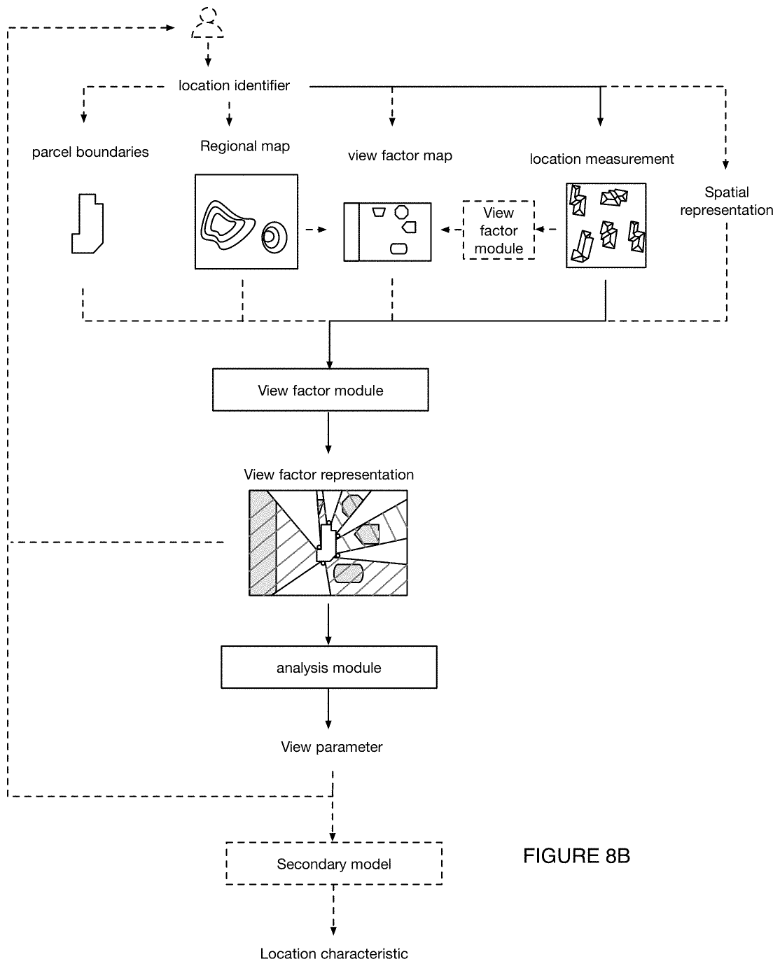

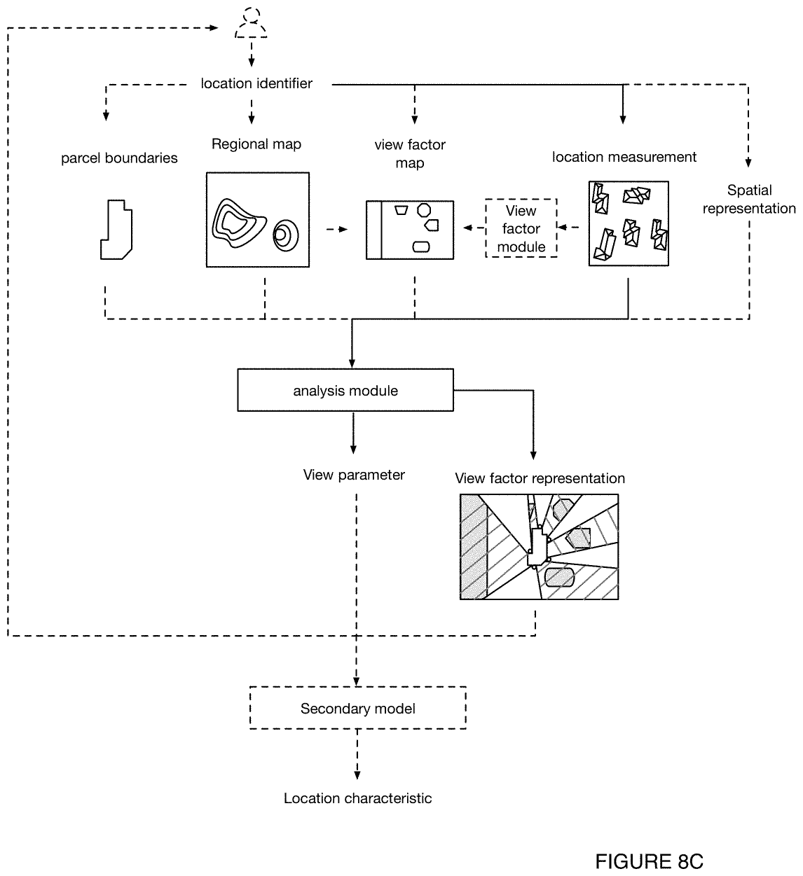

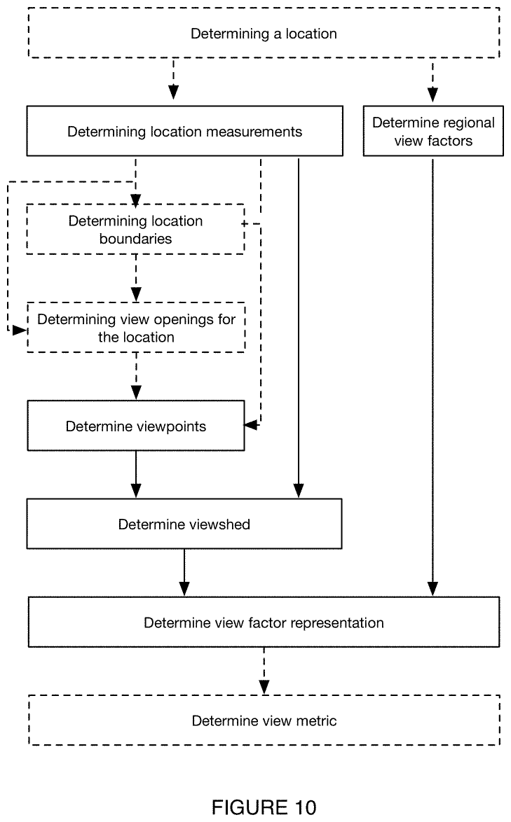

In a first example, the method can include: identifying a location (e.g., a property, a built structure, etc.); determining a set of measurements of the location; determining a set of viewpoints from the set of measurements; determining a viewshed based on the set of measurements and the set of viewpoints; determining a set of regional view factors associated with the location (e.g., a view factor map); determining a view factor representation based on the viewshed and the set of regional view factors; and optionally determining a view parameter (e.g., view score) based on the view factor representation (e.g., examples shown in FIG. 10 and FIG. 8A). In variants, the measurements can include imagery (e.g., aerial imagery, oblique imagery, etc.), 3D representations of the region surrounding the location, and/or other measurements. The set of viewpoints can be determined based on the location's boundary (e.g., a built structure boundary), based on the location's view openings (e.g., windows, balconies, etc.), and/or otherwise determined. The viewshed can be determined by removing the location's volume from the 3D regional representation (e.g., using the location's boundary) and determining the viewshed based on the modified regional representation. In examples, the viewshed can be determined by determining a viewpoint viewshed for each viewpoint based on the modified 3D regional representation, and determining a location viewshed (e.g., by merging the viewpoint viewsheds), or be otherwise determined. The view factor representation can include a map, set, or other representation of the view factors, or segments thereof, that are visible within (e.g., intersect) the viewshed. The view parameter can be calculated or predicted based on a view factor rating (e.g., “beneficial” or +1, “adverse” or −1, “neutral” or 0, etc.) associated with each view factor within the view factor representation, characteristics of the view factor within the view factor representation (e.g., how much of the view factor is visible, which segment of the view factor is visible, the contiguity of the view factor within the viewshed, the proportion of the view occupied by the view factor, etc.), and/or otherwise determined.

In a second example, the method can include: identifying a location; determining a set of measurements of the location (e.g., imagery, 3D regional representation, etc.); and predicting a view parameter and/or view factor representation based on the measurements using a model trained to predict the view score and/or view factor representation respectively (e.g., wherein the view score and/or view factor representation can be determined as described in the first example). An illustrative example is shown in FIG. 8C. In this example, the regional view factor set can be provided as an additional input or be inherently inferred from the location measurements by the model.

However, the method can be otherwise performed.

### 3. Technical Advantages

In variants, the technology for viewshed analysis can confer several technical advantages over conventional methods.

First, variants of the technology can determine the view from a location. This can include determining what is visible (e.g., vegetation, structures, paved surfaces, bodies of water, sky, etc.), how much is visible (e.g., area, distance, contiguity, etc.) from the location (e.g., address, region, geocoordinates, etc.), and/or what is not visible. Variants of the technology can further determine a metric indicative of the qualities of the view. This metric, indicative of the property's view and/or surroundings, can further be provided to an end user or downstream model, wherein the metric can additionally be used to increase accuracy and/or precision of downstream property analyses, such as property valuation or renovation evaluations.

Second, variants of the technology can provide an objective, accurate, and/or precise metric indicative of a subjective property characteristic (e.g., an aesthetic value of a view). In a first example, variants of the technology can determine an objective metric by calculating the metric value based on a set of predetermined scores for each view factor and/or parameters of the visible view factors within the location's viewshed. In a second example, variants of the technology can determine an objective metric by validating the objective metric (and/or differences between different locations' metrics) against: rankings (e.g., an Elo score determined based on the locations' view desirability), view desirability proxies (e.g., errors on predicted proxy values that are attributable to differences in view desirability, such as valuation error), and/or other objective measures.

Third, variants of the technology can determine a more accurate and/or precise viewshed, such as by extending the traditional single-point calculation and considering a property's own physical occlusions. In a first example, the technology determines a more accurate viewshed by: determining a plurality of viewpoints for the property; determining a set of viewsheds for each viewpoint; and merging the viewsheds from the viewpoints into the property viewshed. The viewpoints can be determined from: the property limits, a view opening, and/or otherwise determined. In a second example, a more accurate viewshed can be determined by removing occlusions due to the property or location itself, such as by removing the property area (e.g., pixels, voxels, etc.) from the 2D and/or 3D representation used to calculate the viewshed.

Fourth, variants of the technology can enable a model to determine a parameter related to property view surroundings based on location imagery. In variants, the technology incorporates models with at least one unsupervised layer to output a view parameter by analyzing imagery. This enables the discovery of associations between view and other metrics (e.g., valuation, risk, etc.) otherwise intangible to a human expert.

Fifth, variants of the technology can enable renovation analyses. For example, the viewshed properties can be used to determine what objects (e.g., structures, vegetation, etc.) should be added or removed and/or the characteristics thereof (e.g., pose, density, extent, etc.) to increase the view parameter, block an unfavorable view factor, gain access to a favorable property view, and/or otherwise modify a property's view.

However, further advantages can be provided by the system and method disclosed herein.

### 4. System

The method can be performed using one or more: locations, viewpoints, viewsheds, view factors, view factor representations, view parameters, and/or any other suitable data object or component. All or a portion of the data objects can be determined: in real- or near-real time, asynchronously, responsive to occurrence of an event (e.g., receipt of a request, receipt of new data, etc.), periodically (e.g., every day, month, year, etc.), before a stop event, and/or at any other suitable time. The method can additionally or alternatively be performed using a system including a set of modules.

The system can be used with one or more locations. The locations can function as test locations (e.g., locations of interest), training locations (e.g., used to train the model(s)), and/or be otherwise used.

Each location can be or include: land (e.g., a parcel, any other region of land), a subsection of land, a geographic location, a property (e.g., identified by a property identifier, such as an address or lot number), a point of interest, a set of geographic coordinates, a region, a landmark, a property component or set or segment thereof, a mobile structure (e.g., a ship), a built structure (e.g., primary structure, auxiliary structure, etc.), and/or otherwise defined. For example, the location can include both the underlying land and improvements (e.g., built structures, fixtures, etc.) affixed to the land, only include the underlying land, or only include a subset of the improvements (e.g., only the primary building, only a specific building unit). The location can be: residential property (e.g., homes), commercial properties (e.g., industrial centers, forest land, quarries, etc.), and/or any other suitable property class. In illustrative examples, the view parameter(s) can be determined for: a floor of a building (e.g., the third floor of a building), a landmark (e.g., the top of a statue), an apartment within a larger building, and/or any other suitable location.

Property components can include: built structures (e.g., primary structure, accessory structure, deck, pool, etc.); subcomponents of the built structures (e.g., roof, siding, framing, flooring, living space, bedrooms, bathrooms, garages, foundation, HVAC systems, solar panels, slides, diving board, etc.); permanent improvements (e.g., pavement, statutes, fences, etc.); temporary improvements or objects (e.g., trampoline); vegetation (e.g., tree, flammable vegetation, lawn, etc.); land subregions (e.g., driveway, sidewalk, lawn, backyard, front yard, wildland, etc.); debris; and/or any other suitable component. The location and/or components thereof are preferably physical, but can alternatively be virtual.

Each location can be identified by one or more location identifiers. A location identifier (location ID) can include: geographic coordinates, an address, a parcel identifier, a block/lot identifier, a planning application identifier, a municipal identifier (e.g., determined based on the ZIP, ZIP+4, city, state, etc.), a geocode (e.g. geohash, OLC, etc.), a geospatial index (e.g., H3), and/or any other identifier. The location identifier can be used to retrieve location information, such as parcel information (e.g., parcel boundary, parcel location, parcel area, etc.), location measurements, location descriptions (e.g., property descriptions), and/or other location data. The location identifier can additionally or alternatively be used to identify a location component, such as a primary building or secondary building, and/or be otherwise used.

Each location can have one or more view openings. A view opening can be: a feature of a location that admits light or air; a feature of a location that allows people to see out of the location (or out of a portion thereof); a feature that optically connects the location and an ambient environment (e.g., optically connects a property interior with the surrounding environment, optically connects a property surface with the surrounding environment, etc.); an opening in a built structure; a flat external surface of the built structure; and/or be otherwise defined. View openings may include windows, balconies, lawns, porches, yards, patios, doorways, rooftop decks, a location boundary, a property perimeter, or any other suitable feature. A view opening can be represented in 2D or 3D by a boundary, an image segment, a set of voxels, a set of points, a spatial fence, a geometric model, or any other suitable representation. A view opening can be associated with: an extent, a pose, a position (e.g., relative to the built structure, relative to global coordinates, etc.), an orientation (e.g., relative to the built structure, relative to global coordinates, etc.), and/or any other suitable set of attributes. For example, a view opening can include: an extent in space (e.g., a set of voxels or points, a geofence, etc.), an orientation (e.g., a normal vector orthogonal to the primary plane of the view opening), a position (e.g., geocoordinates, a position relative to the location, etc.), and/or be otherwise defined.

View openings can be: manually identified, automatically identified (e.g., using the view module), inferred (e.g., based on images of views from the location), and/or otherwise determined.

Each location can be associated with location information, which can be used to: determine the viewpoints, viewshed, regional view factors, view factor representation, view parameter, and/or any other suitable data. The location information can be static (e.g., remain constant over a threshold period of time) or variable (e.g., vary over time). The location information can be associated with: a time (e.g., a generation time, a valid duration, a season, etc.), a source (e.g., the information source), an accuracy or error, and/or any other suitable metadata. The location information is preferably specific to the location, but can additionally or alternatively be from other location (e.g., neighboring properties, other location sharing one or more attributes with the location). Examples of location information can include: measurements, descriptions, attributes, auxiliary data, location areas, and/or any other suitable information about the location.

Location measurements preferably measure an aspect about the location, such as a visual appearance, geometry, and/or other aspect. In variants, the location measurements can depict a location (e.g., location of interest) and/or a property (e.g., the property of interest), but can additionally or alternatively depict the surrounding geographic region, adjacent properties, and/or other factors. The measurement can be: 2D, 3D, and/or have any other set of dimensions. Examples of measurements can include: images, surface models (e.g., digital surface models (DSM), digital elevation models (DEM), digital terrain models (DTM), etc.), point clouds (e.g., generated from LIDAR, RADAR, stereoscopic imagery, etc.), depth maps, depth images, virtual models (e.g., geometric models, mesh models), audio, video, radar measurements, ultrasound measurements, and/or any other suitable measurement. Examples of images that can be used include: RGB images, hyperspectral images, multispectral images, black and white images, grayscale images, 3D images, panchromatic images, IR images, NIR images, UV images, thermal images, and/or images sampled using any other set of wavelengths; images with depth values associated with one or more pixels (e.g., DSM, DEM, etc.); and/or other images.

The measurements can include: remote measurements (e.g., aerial imagery, such as satellite imagery, balloon imagery, drone imagery, etc.), local or on-site measurements (e.g., sampled by a user, streetside measurements, etc.), and/or sampled at any other proximity to the location. The remote measurements can be measurements sampled more than a threshold distance away from the location, such as more than 100 ft, 500 ft, 1,000 ft, any range therein, and/or sampled any other distance away from the location. The measurements can be: top-down measurements (e.g., nadir measurements, panoptic measurements, etc.), side measurements (e.g., elevation views, street measurements, etc.), angled and/or oblique measurements (e.g., at an angle to vertical, orthographic measurements, isometric views, etc.), interior measurements, and/or sampled from any other pose or angle relative to the location. The measurements can depict the location exterior, the location interior, and/or any other view of the location. In an example, the measurement can be sampled from the location interior (e.g., from within the building) and include a view out a window or deck, such that the measurement depicts a portion of the view from the location and/or the region surrounding the location (e.g., the ambient environment).

The measurements can be a full-frame measurement, a segment of the measurement (e.g., the segment depicting the location, such as that depicting the location's property parcel; the segment depicting a geographic region a predetermined distance away from the location; etc.), a merged measurement (e.g., a mosaic of multiple measurements), orthorectified, and/or otherwise processed.

The measurements can be received as part of a user request, retrieved from a database, determined using other data (e.g., segmented from an image, generated from a set of images, etc.), synthetically determined, and/or otherwise determined.

The measurements can include images associated with the location. The images can be used to determine: the viewpoints, the view factors, and/or be otherwise used. For example, the images can be used to determine the location boundary and/or view openings, wherein the viewpoints are determined based on the location boundary and/or view openings. In a second example, the images can be used to determine the view factors and optionally view parameters within a region surrounding the location. The images can include: images depicting the location, images depicting a view from the location, and/or images from any other suitable perspective. The images can include exterior imagery, interior imagery, and/or any other imagery. The images can include aerial imagery, orthographic and/or oblique imagery, and/or any other suitable imagery.

The measurements can include a 3D representation associated with the location. The 3D representation can be used to determine the viewshed for the location, to determine the location viewpoints, to determine the regional view factors, and/or be otherwise used. The 3D representation can be determined from measurements (e.g., lidar, radar, etc.), using photogrammetry, stereoscopic techniques, and/or otherwise determined. The 3D representation is preferably a digital surface model (DSM) or digital elevation model (DEM), but can additionally or alternatively be a point cloud, digital terrain model, a geometric model (e.g., mesh model), a spatial model, and/or any other suitable 3D representation. In a first variant, the 3D representation is of the location itself. In a second variant, the 3D representation is a regional representation (e.g., 3D regional representation) that represents a region that encompasses the location, but can additionally or alternatively represent a region that intersects with a portion of the location, represent a region adjacent the location, and/or represent any other suitable region associated with the location. The region can be: a region coextensive with the location images, a region with a predetermined extent (e.g., encompasses a 1 square mile, 2 square miles, 10 square miles, 50 square miles, and/or otherwise-sized region about the location), a region coextensive with a neighborhood or other government-defined region, a region of the neighborhood, and/or be otherwise defined.

However, the measurements can include any other suitable measurement of the location.

The location information can include location descriptions. The location description can be: a written description (e.g., a text description), an audio description, and/or in any other suitable format. The location description is preferably verbal but can alternatively be nonverbal.

The location information can include auxiliary data. Examples of auxiliary data can include property descriptions, permit data, insurance loss data, inspection data, appraisal data, broker price opinion data, property valuations, property attribute and/or component data (e.g., values), and/or any other suitable data. Examples of property descriptions can include: listing descriptions (e.g., from a realtor, listing agent, etc.), property disclosures, inspection reports, permit data, appraisal reports, and/or any other text based description of a property.

The location information can include location attributes, which can function to represent one or more aspects of a given property. The location attributes can be semantic, quantitative, qualitative, and/or otherwise describe the property. Each location can be associated with its own set of location attributes, and/or share location attributes with other locations. The location attributes can be: manually determined, retrieved from a database, automatically determined (e.g., extracted from an aerial image, an oblique image, a 3D representation of the location, etc.), and/or otherwise determined. For example, the location attributes can be determined by a set of attribute models. An attribute model (e.g., location attribute model, property attribute model, etc.) can determine values for a single attribute (e.g., be a binary classifier, be a multiclass classifier, etc.), multiple attributes (e.g., be a multiclass classifier), and/or for any other suitable set of attributes. A single attribute value can be determined using a single attribute model, multiple attribute models, and/or any other suitable number of attribute models.

Examples of location attributes can include: structural attributes (e.g., presence, geometry, dimensions, pose, and/or other attributes of property components, etc.), condition attributes (e.g., roof quality, yard debris quality, etc.), record attributes (e.g., number of beds, baths, etc.), and/or any other suitable attribute. In variants, these location attributes can be used to: determine where to position viewpoints, predict the view parameter, and/or otherwise used. For example, viewpoints can be positioned on roofs with a slope less than a threshold angle, decks, and/or other property components that are accessible and/or can support a human, and not be positioned on roofs or decks with less than a threshold condition or quality. In examples, location attributes and/or values thereof can defined and/or determined as disclosed in U.S. application Ser. No. 17/529,836 filed on 18 Nov. 2021, U.S. application Ser. No. 17/475,523 filed 15 Sep. 2021, U.S. application Ser. No. 17/749,385 filed 20 May 2022, U.S. application Ser. No. 17/870,279 filed 21 Jul. 2022, and/or U.S. application Ser. No. 17/858,422 filed 6 Jul. 2022, each of which is incorporated in its entirety by this reference (e.g., wherein features and/or feature values disclosed in the references can correspond to attributes and/or attribute values).

However, the location information can include any other suitable information about the location.

Each location can be associated with one or more location boundaries. The location boundary can define the region from which the viewshed should be computed, and can be used to mask the 3D regional representation (such that the location's walls do not obscure the viewshed). The location boundary can be: the boundary of the location's primary built structure (e.g., primary building), the boundary of a living structure (e.g., a house, an ADU, etc.), the boundary of a human-accessible structure, the parcel perimeter, the walls of built structure, property limits, and/or the boundary of any other suitable location component or property component. The boundary is preferably 2D, but can alternatively be 3D.

The location boundaries can be: determined using property feature segmentation, retrieved (e.g., from a database), determined from an API, specified by a user in a request through an interface, manually determined, be a default size and/or shape, and/or be otherwise determined. For example, the location boundary can be determined by: receiving a location measurement (e.g., image, DSM, appearance measurement, geometric measurement, etc.) for a location, optionally determining parcel data for the location, optionally determining a location measurement segment corresponding to the location's parcel, and determining a built structure segment (e.g., roof mask, roof polygon, primary building, etc.) based on the location measurement (and/or location measurement segment) using a trained segmentation model (example shown in FIG. 8A). In other examples, the location boundary can be determined as discussed in U.S. application Ser. No. 17/336,134 filed 1 Jun. 2021, U.S. application Ser. No. 17/749,385 filed 20 May 2022, and/or U.S. application Ser. No. 17/870,279 filed 21 Jul. 2022, each of which is incorporated in its entirety by this reference. However, the location boundaries can be otherwise determined.

Each location can be associated with a location area, which can represent the physical area associated with the location within a location measurement. For example, the location area can include the location measurement area associated with the primary structure of a property. The location areas can be predetermined, segmented by a model, retrieved from a third party source, and/or otherwise determined. The location area can be 3D, 2D, a vector representation, and/or otherwise represented. Examples of location areas can include: volumes (e.g., a set of voxels, hulls, meshes, 3D points, wireframes, polyhedrons, etc.), 2D areas (e.g., a set of pixels, image segments, etc.), and/or any other suitable area representation.

Locations can be associated with one or more viewpoints (e.g., location viewpoints). A viewpoint can be a point that is used by a viewshed algorithm to determine the viewshed from said point and/or be otherwise defined. The viewpoint can be defined in 2D, 3D, 6D (e.g., be defined by a pose including position and orientation), and/or be otherwise defined. A viewpoint may be defined: by a geographic location and an elevation, relative to another point, or any other suitable means of identifying a position. Viewpoints are preferably determined algorithmically, by a viewpoint module. However, viewpoints may alternatively be received from a user (e.g., via a GUI) or otherwise determined. The viewpoints can be: within the built structure (e.g., be recessed within the boundaries of the built structure), lie along the perimeter of the built structure, be arranged outside of the built structure, and/or be otherwise located.

In a first variant, the location includes a single viewpoint. The single viewpoint can be located: at the highest point of the location, at or near a centroid of the location (e.g., of the built structure), at or near a horizontal centroid of the location and at a predetermined height from a vertical reference (e.g., 5 ft off the topmost floor, 2 ft lower than the uppermost point of the roof, etc.), and/or at any other suitable position.

In a second variant, the set of viewpoints are positioned along a boundary of the location (e.g., along a boundary of a built structure).

In a third variant, the set of viewpoints are defined by the locations of view openings. In a first example, the viewpoints are positioned along the exterior, interior, upper, or lower surface of each view opening. In a second example, the viewpoints are positioned a predetermined distance away from a reference surface of the view opening. In a specific example, the viewpoints can be positioned a predetermined distance away from the interior of a window (e.g., between 2-6 ft away from the interior surface of a window). In a second specific example, the viewpoints can be positioned a predetermined distance away from a floor (e.g., between 2-7 ft away from the floor or other flat surface.

However, the viewpoints can be otherwise defined.

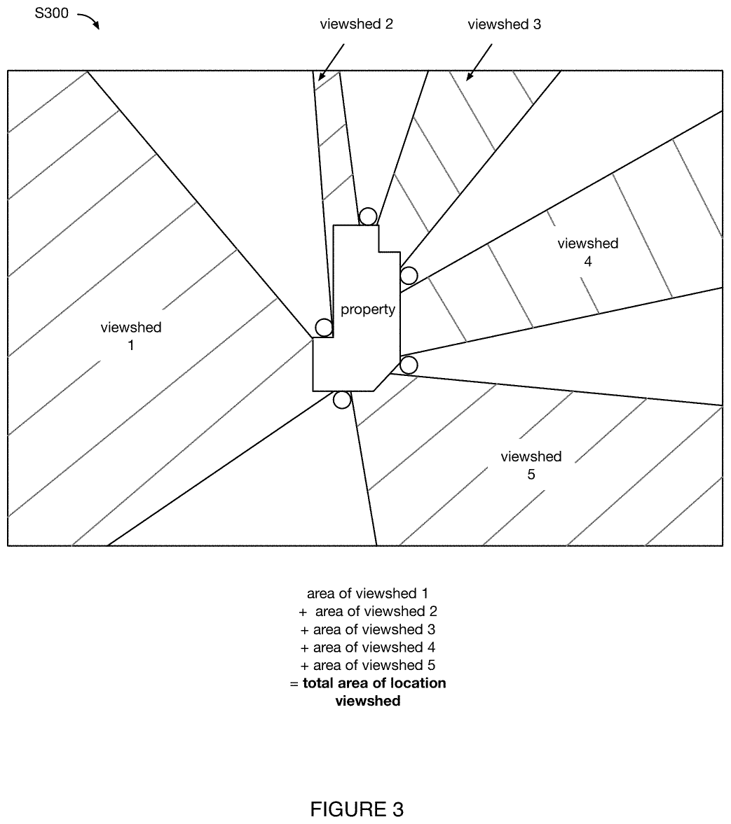

Each location can be associated with one or more viewsheds (e.g., location viewsheds). A viewshed can include or define the region that is visible from a set of one or more viewpoints and/or a location (e.g., example depicted in FIG. 3). Each viewshed can be associated with one or more locations. The viewshed is preferably a 2D projection on a geographic map (e.g., a projection onto an x-y plane), but can alternatively include a plurality of sightlines, be a 3D representation (e.g., include nonzero voxels for visible regions, include zero-valued voxels for obstructed regions, etc.), include a set of geofences (e.g., representing visible regions and/or obstructed regions), or be otherwise represented. Each viewshed can be solid or patchy (e.g., include gaps for regions that cannot be seen from the location). Each viewshed can include one or more viewshed segments (e.g., separated from an adjacent segment by more than a threshold distance). The viewshed is preferably georeferenced (e.g., the viewshed can be related to a set of geographic coordinates), but can alternatively not be georeferenced. The viewshed can be associated with one or more viewshed parameters. Examples of viewshed parameters can include: the overall viewshed area, the overall viewshed contiguity, viewshed dimensions (e.g., minimum extent, maximum extent, etc.), viewshed bias (e.g., whether the viewshed covers more area in one direction versus another), viewshed segment parameters (e.g., for individual segments of the viewshed), the number of viewshed segments, the viewshed contiguity (e.g., how patchy it is), and/or any other set of parameters descriptive of an attribute of the viewshed. Examples of viewshed segment parameters include: the viewshed segment's area, the viewshed segment's contiguity, the viewshed segment's dimensions (e.g., depth, width, etc.), the viewshed segment's dimensional change (e.g., how quickly the segment's width changes with distance away from the location), and/or any other parameter describing a viewshed segment's attribute.

Each location can be associated with a single viewshed or multiple viewsheds. For example, a given location can include multiple viewsheds (and/or a single viewshed can include multiple viewshed segments), wherein each viewshed (and/or viewshed segment) can be associated with a different location viewpoint, different gaps between view obstructions adjacent the location, and/or otherwise defined.

In a first variant, the location can be associated with a single viewshed. The viewshed can be generated by aggregating the viewsheds from multiple location viewpoints, be determined from a single viewpoint, and/or be otherwise determined. In a second variant, the location can be associated with multiple viewsheds (e.g., one for each viewpoint). However, the location can be associated with any other number of viewsheds.

The viewshed for the location is preferably determined based on a set of location viewpoints (e.g., specified by a set of latitude, longitude, and/or elevation values) and a 3D regional representation associated with the location (e.g., digital surface model, digital elevation model, digital terrain model, point cloud, etc.), but can additionally or alternatively be determined based on one or more location boundaries, images of the view from inside a location built structure, and/or any other suitable input information. The viewshed is preferably determined by a viewshed module, but can alternatively be otherwise determined.

Each location can be associated with one or more sets of view factors, which function to define the potentially visible objects or features near the location. Each location can be associated with a single set of view factors and/or multiple sets of view factors (e.g., for different view openings, different times of the year, etc.).

A view factor can be a physical feature or object with a visual appearance, but can be otherwise defined. Examples of view factors can include structures (e.g., roof, wall, pool, court, etc.), paved surfaces (e.g., road, parking lot, driveway, alleyway, etc.), vegetation (e.g., lawn, forest, garden, etc.), waterfronts (e.g., lake waterfront, ocean water front, canal waterfront, etc.), geographic regions (e.g., neighborhood, city, etc.), landmarks (e.g., Eiffel tower, World Trade Center, etc.), a natural occurrence (e.g., sky, mountain, etc.) and/or any other suitable view factor.

Each view factor can be associated with: a set of georeferenced positions and/or boundaries, a set of dimensions, a set of view factor parameters, and/or any other view factor information.

Each view factor can be associated with or represented as a geographic extent (e.g., a geofence), a geometric extent (e.g., a 3D view factor model, etc.), a set of voxels or points, a single point, a set of surfaces (e.g., depicting the view factor faces, determined by projecting images of the view factor onto a geometric model of the view factor, etc.), a pose (e.g., relative to the location, relative to a global reference), and/or with any other suitable representation. Each view factor can be associated with: an area (e.g., lateral area, vertical area, etc.), volume, and/or any other suitable characterization. The view factor is preferably georeferenced (e.g., the view factor can be associated with a set of geographic coordinates), but can alternatively not be georeferenced.

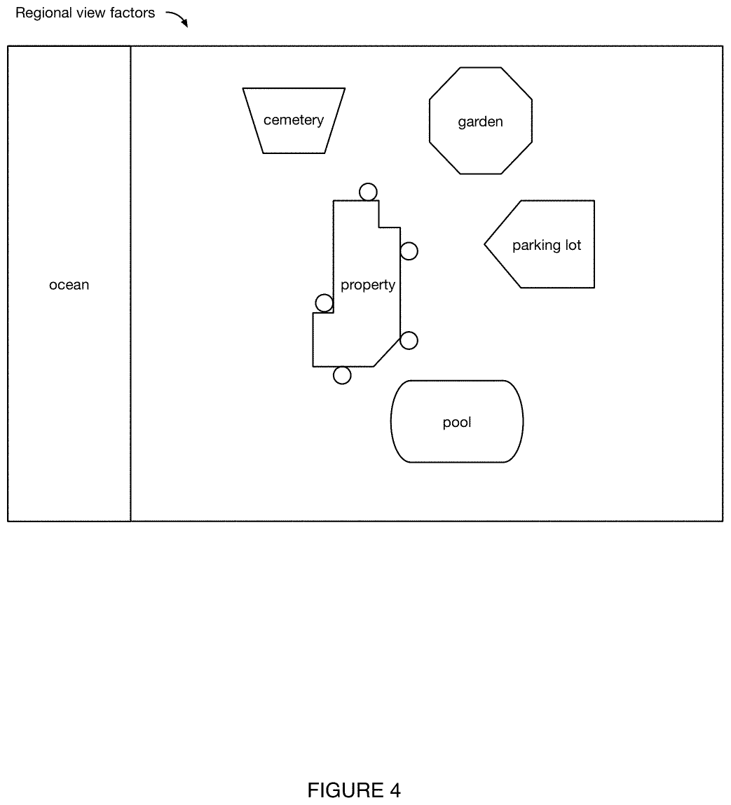

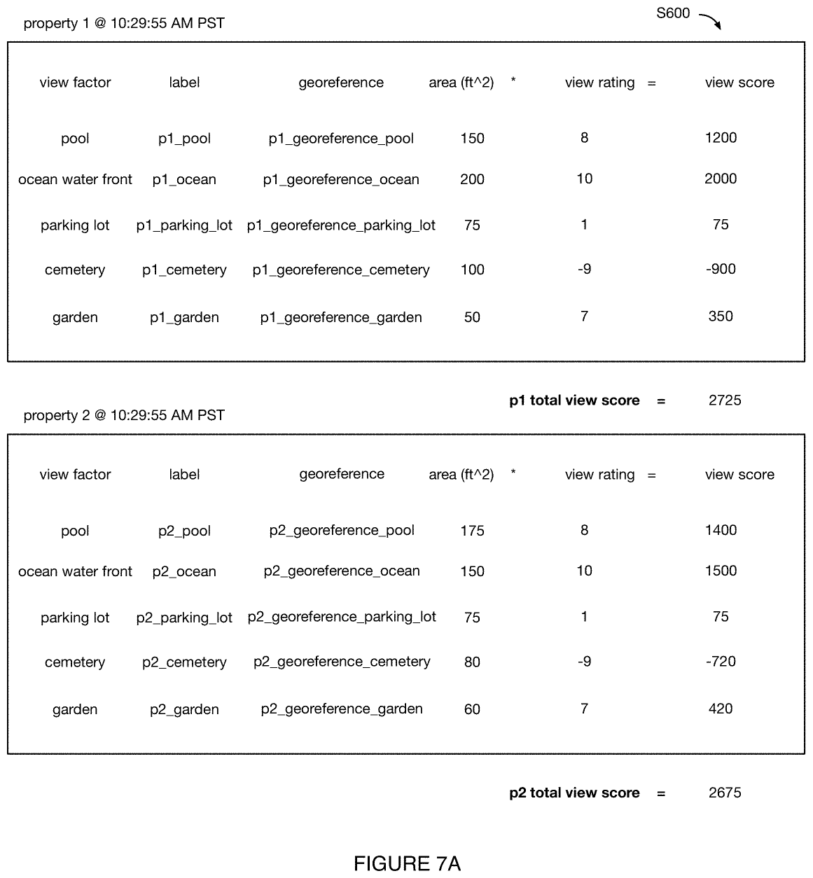

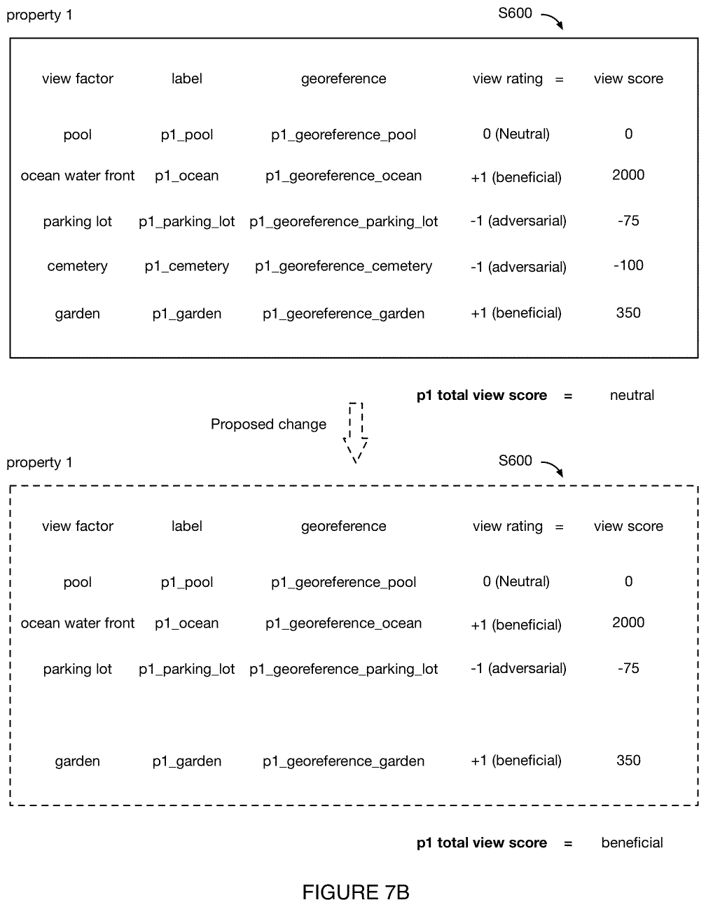

Each view factor can be associated with one or more one or more view factor parameters, but can additionally or alternatively not be associated with a parameter. View factor parameters can be quantitative, qualitative, discrete, continuous, binary, and/or otherwise structured. The view factor parameter for each view factor can be: manually assigned, learned, extracted from industry standards, and/or otherwise determined. View factor parameters can include: a view factor label or category (e.g., “ocean,” “power plant,” “tree,” “trash”; example shown in FIG. 4), a classification (e.g., vegetation, building, water, manmade vs. natural, etc.), a view factor rating, a view factor instance identifier (e.g., a globally or locally unique identifier), other desirability attributes (e.g., other sensory attributes, such as odor, environmental attributes, such as toxicity or smoke, etc.) and/or any other parameters. In examples, the view factor rating can be represented numerically (e.g., on a scale of 0 to 10, on a scale of −1 to 1, etc.; example shown in FIG. 7), categorically (e.g., adverse, neutral, beneficial), both (e.g. 1-3=adverse, 4-7=neutral, 8-10=beneficial), and/or otherwise represented. However, the view factor rating can be otherwise constructed and determined.

The view factor set associated with a location preferably includes the view factors within a region encompassing the location of interest (e.g., a regional view factor set), but can alternatively include view factors from other regions. The region encompassing the location of interest can include: a neighborhood, a radius from the location of interest (e.g., a predetermined radius, a radius determined based on the density and/or topography of the region), the extent of one or more aerial images depicting the location of interest, the 3D representation's region, a predetermined region relative to the location (e.g., within a predetermined distance from the location), a region determined based on the density of view factors and/or obstructions (e.g., smaller region for more dense environments, larger region for less dense environments, or vice versa), for a region not associated with the location (e.g., not encompassing the location), for a set of locations (e.g., for a group of condominiums), for a territory (e.g., the country of France), a region determined by the user, the location's viewshed, and/or be any other suitable geographic region. For example, the view factor region can encompass a geographic region surrounding the location (e.g., on all sides, on 0-100% of the location boundary, centered on the location, etc.), but can alternatively encompass a geographic region adjacent the location and/or be otherwise related to the location. In another example, the view factor region can be limited to a predetermined distance surrounding the location.

The set of view factors can be represented as: a view factor map, an array of view factors, a set of geofences, and/or using any other suitable data structure. The view factor map can include: a land use land cover (LULC) map, land use map, land cover map, set of classified polygons indicating the land use and/or land cover (e.g., streets, parks, bodies of water, structure types, points of interest, etc.), a set of geofences or geolocations associated with view factor information, an image (e.g., 3D imagery), and/or any other suitable geographic representation. The view factor map is preferably 2D (e.g., be an image, a vector representation of areas, etc.), but can additionally or alternatively be 3D, text-based, or have any other suitable structure or format.

The view factor map is preferably automatically generated, but can alternatively be manually generated. The set of view factors and/or parameters thereof can be: predetermined, retrieved from a database (e.g., proprietary database, third party database, etc.), determined from the location information (e.g., using a view factor module), determined from other information, and/or otherwise determined. For example, a view factor map can be retrieved from a government database or a third party database (e.g., Google Maps™). In this example, only the segment of the view factor map associated with the location (e.g., encompassing the location, surrounding the location, within a predetermined distance from the location, etc.) is preferably retrieved; alternatively, the entire view factor map can be retrieved. In a second example, a view factor map can be determined from a location measurement (e.g., an aerial image) using a set of view factor classifiers (e.g., instance-based segmentation modules, semantic segmentation modules, object detectors, etc.) trained to identify and/or segment view factor classes depicted in the location measurement(s). The set of view factor classifiers can include a view factor classifier for each view factor, a single view factor classifier trained to identify multiple view factors, and/or other classifiers.

However, the view factor map can be otherwise determined.

Each location can be associated with one or more view factor representations. The view factor representation functions to represent the set of visible view factors and/or segments thereof within the viewshed for a location, and/or can be otherwise defined. The view factor representations can be used to determine the view parameter, used as an input to a downstream model, and/or otherwise used. Each location can be associated with a single view factor representation or multiple view factor representations (e.g., for different view openings, viewing directions, time of year, etc.).

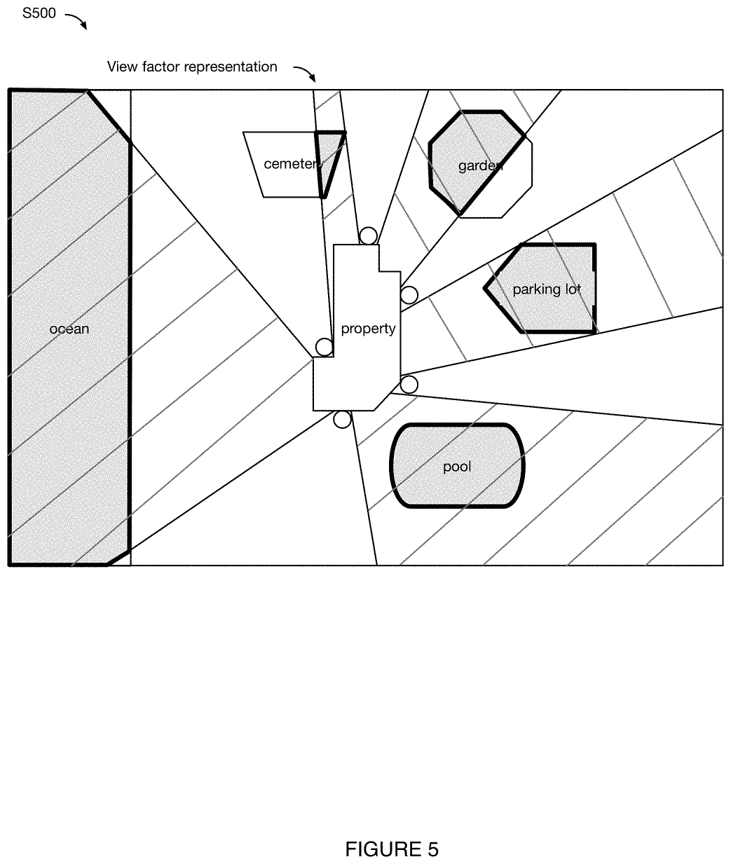

The view factor representation can be: a map (e.g., an annotated map), an image, a list (e.g., a list of view factors within the viewshed), a matrix, multi-dimensional array, a spatial representation, text, or any other suitable representation. For example, the view factor representation can include: a 2D or 3D map depicting the segments of the view factors visible within the viewshed (e.g., example shown in FIG. 5); an array of the view factor segments within the viewshed; and/or have any other suitable format or structure. The view factor representation can include: a geographic extent, view factor and/or segment appearances, view factor and/or segment geometry, view factor parameters (e.g., labels, categories, ratings, etc.) for each of the view factors within the viewshed, and/or any other suitable information about the visible view factors within the viewshed. In a first example, the view factor representation includes a map of the view factor segments falling within the location's viewshed projection (e.g., top-down projection). In a second example, the view factor representation includes a set of georeferenced vertical slices depicting the face(s) of each view factor intersecting the sightlines of the location's viewshed (e.g., wherein the slices depict the segment of the view factor where the sightline terminates). However, the view factor representation can be otherwise constructed.

The view factor representation is preferably determined based on the view factor set and the viewshed, but can additionally or alternatively be determined based directly on the location information (e.g., location measurements, location description, etc.), be determined directly from a regional representation (e.g., DSM, point cloud, 3D model, map, etc.), be determined directly from a view factor map, be determined from a combination of the above, and/or be otherwise determined. The view factor representation can be determined using the overlaying module, or otherwise determined.

The view factor representation be used to determine and/or can include: the proportion of a view factor visible within the viewshed, the contiguity of a view factor visible from the location, the distance between a view factor and the location, the proportion of the viewshed occupied by a view factor, the orientation of the view factors relative to the location (e.g., cardinality, such as east, west, north, south; relative height, such as above or below, etc.; viewing angles from the location; etc.), the area of each view factor within the viewshed, a timeseries of any of the above, or any other suitable visible view factor attribute. The contiguity of the view factor can be or be determined based on: a contiguity classification (e.g., broken up or large contiguous portions visible), a distribution of the visible view factor segments (e.g., the mean visible view factor segment size, the count of discrete visible view factor segments, etc.), the obstruction causing the visual discontinuity (e.g., whether the obstruction is foliage or a solid building), and/or be otherwise determined.

Each location or set thereof can be associated with a view parameter, which functions as objective metrics indicative of the view from the location. Each location can be associated with a single view parameter and/or multiple view parameters. Examples of multiple view parameters for a given location can include: different view parameters for different view openings, different view parameters for different times of the year, different view parameters for different qualities of the view (e.g., aesthetic score, health score, toxicity score, utility score, etc.), and/or property aspects. The multiple view parameters can be determined for the same or different timeframe, for the same or different set of viewpoints, and/or be otherwise related and/or differentiated.

The view parameter is preferably a view metric, but can additionally or alternatively be the view factor representation and/or any other suitable view parameter.

The view parameter can function as a singular score representative of the impact that the viewshed and/or view factors adjacent the location can have on the location (e.g., the location value, the physical location, etc.). The view parameter (e.g., view metric) can be represented numerically (e.g., on a scale 1-10), categorically (e.g., adverse, neutral, beneficial), and/or otherwise represented. The view parameter for the location can be one view metric (e.g., a numerical view score; 8), multiple view metrics (e.g., a numerical view score linked to a categorical view rating; 8 and beneficial), and/or any other suitable number of view metrics. The view parameter can be a percentage, a measurement, a distribution, and/or any other suitable value.

The view parameter can be determined using: the view factor representation (e.g., the set of visible view factors), the respective view ratings for each view factor, the area of each view factor within the viewshed, the visible view factor attributes for each visible view factor (e.g., visible percentage of the view factor, obstructed percentage of the view factor, contiguity, percentage of the overall view occupied by the visible view factor segment, etc.), and/or any other suitable input or information. The view parameter can be determined by an analysis module (e.g., a view parameter model), an equation, and/or otherwise determined.

In a first variant, a view parameter is determined based on the view factor representation for each location.

In a second variant, a view parameter is determined for a set of locations (e.g., properties within a neighborhood). In a first embodiment, the view parameter includes a distribution or map of view metrics across the location set. In a second embodiment, the view parameter includes a statistical summary of the view metrics (e.g., mean, average, etc.). In a third embodiment, the view parameter includes ranking of the locations within the set, according to the respective view metrics. In a fourth embodiment, the view parameter includes a comparison between the view metric for the location set against the view metric for a second location set.

However, the view parameter can be otherwise defined and/or determined.

The method can be performed using one or more modules. The modules can include: a view openings module, a viewpoint module, an optional view factors module, a viewshed module, an overlaying module, a view parameter module, and/or any other suitable module. The modules can be executed by the computing system or a component thereof. The output of each module can be stored in a datastore and/or discarded. The system can additionally or alternatively include any other suitable module that provides any other suitable functionality. Each module can be generic (e.g., across time, geographic regions, location class, etc.), and/or be specific to: different timeframes (e.g., different years, different seasons, etc.), a geographic region, a geographic region class (e.g., suburb, city, etc.), location class (e.g., single family homes, multifamily homes, etc.), and/or otherwise generic or specific.

Each module can be, include, or leverage: neural networks (e.g., CNN, DNN, etc.), an equation (e.g., weighted equations), regression (e.g., leverage regression), classification (e.g., binary classifiers, multiclass classifiers, semantic segmentation models, instance-based segmentation models, etc.), generative algorithms (e.g., diffusion models, GANs, etc.), segmentation algorithms (e.g., neural networks, such as CNN based algorithms, thresholding algorithms, clustering algorithms, etc.), rules, heuristics (e.g., inferring the number of stories of a property based on the height of a property), instance-based methods (e.g., nearest neighbor), regularization methods (e.g., ridge regression), decision trees, Bayesian methods (e.g., Naïve Bayes, Markov, etc.), kernel methods, statistical methods (e.g., probability), deterministics, support vectors, genetic programs, isolation forests, robust random cut forest, clustering, selection and/or retrieval (e.g., from a database and/or library), comparison models (e.g., vector comparison, image comparison, etc.), object detectors (e.g., CNN based algorithms, such as Region-CNN, fast RCNN, faster R-CNN, YOLO, SSD—Single Shot MultiBox Detector, R-FCN, etc.; feed forward networks, transformer networks, and/or other neural network algorithms), SIFT, any computer vision and/or machine learning method (e.g., CV/ML extraction methods), natural language processing models, lookup tables, third party interfaces (e.g., API interfaces), and/or any other suitable model, algorithm, or methodology. The models can process input bidirectionally (e.g., consider the context from both sides, such as left and right, of a word), unidirectionally (e.g., consider context from the left of a word), and/or otherwise process inputs. The models can be: handcrafted, trained using supervised training, and/or trained using unsupervised training, and/or otherwise determined. The models can be pretrained or untrained. The system can include a single version of each model, or include one or more instances of the same model for different: times of the year, location types (e.g., a first set for built structures, a different set for land, etc.), geographic regions (e.g., neighborhoods), geographic region classes (e.g., urban, suburban, rural, etc.), and/or other location parameter.

One or more of the modules can be trained, learned, developed, or otherwise determined based on objective data, such as MLS data, sale prices, appraised valuations, the relationship between the location's external metric and the population's external metric (e.g., whether the location's valuation is above or below a population average, the distance between the location's valuation from the population average, etc.), and/or other external metrics.

The view openings module can function to identify potential view openings for a location, and can output information pertaining to each view opening. Outputs preferably include the positions of view openings relative to the location, and optionally further include dimensions, orientation (e.g., pose), type (e.g., window, outdoor space, doorway, parcel boundary, etc.), quality (e.g., smoggy, frosted, opaque, etc.), and any other attributes of the view opening. Inputs to the view openings module may include any form of location information (e.g., descriptions, measurements, imagery, etc.). The view opening module is preferably a segmentation module, but can additionally or alternatively be an object detector and/or other classifier. The view opening module can be specific to a given view opening class (e.g., window, deck, etc.), and/or be a multiclass classifier configured to predict multiple view opening classes.

The viewpoint module can function to determine viewpoints, which can be used by the viewshed algorithm to determine a viewshed. The viewpoint module can output one or more viewpoints for a location. The viewpoint module can determine the viewpoints based on: a location's view openings (e.g., from the view openings module), a location's boundary, a location's measurements (e.g., image, 3D model, etc.), and/or any other input. The module can alternatively offer a user the option to select viewpoints (e.g. through a 3D GUI, through text-based commands, etc.). The system can include a single viewpoint module or multiple viewpoint modules (e.g., for different types of view openings). The viewpoint module can be or include: a trained model configured to detect viewpoints given a location measurement (e.g., image) or view opening (e.g., trained on location measurements and/or view openings labelled with viewpoints); a set of heuristics; and/or any other suitable model. For example, the viewpoint module can: randomly distribute viewpoints within a constrained region (e.g., throughout a yard or other view opening), evenly distribute viewpoints within a constrained region (e.g., over the surface of a window), place single viewpoints at a specified position relative to a view opening (e.g., at centroid of a window, recessed from a view opening, etc.), at a specified position relative to a location component (e.g., 6 feet above each floor, 2 meters below the roof, at the centroid of a structure, etc.), assign multiple viewpoints separated by a threshold angle to each candidate viewpoint location, assign a viewpoint vector or direction normal to the view opening broad face, and/or apply any other suitable heuristic or rule to position the viewpoints.

In variants, the function of the viewpoint module can be bypassed or alternatively implicitly performed by a set of neural network layers, or any other suitable model. For example, a model may be trained to determine viewpoints based on measurements, descriptions, imagery, a view opening representation, or other location information.

The view factor module can function to determine a view factor set and/or view factor parameters, to refine a view factor map (e.g., assign view factor ratings to individual view factors on a map, classify and label view factors from an aerial image, etc.), and/or perform any other functionality. The view factor module can determine the view factor set based on: the location identifier, a region identifier, the location information (e.g., location measurements, location descriptions, etc.), and/or any other suitable input. In a first variant, the view factor module retrieves a view factor map from a third party resource (e.g., using an API request). In a second variant, the view factor module includes a set of view factor classifiers (e.g., segmentation modules, object detectors, etc.) trained and/or configured to identify instances of one or more view factor classes within a measurement. In an example, the view factor classifiers can be the same as or overlap with the location attribute modules (e.g., configured to detect and/or extract the location attributes). However, the view factors can be otherwise determined.

The view factor module and/or another module can additionally or alternatively determine the view factor parameters (e.g., view factor ratings). In a first variant, the view factor parameters are retrieved from a third party resource (e.g., the same or different third party resource that the view factor set was retrieved from). In a second variant, the view factor parameters are predetermined for each class, and assigned based on the view factors appearing within the view factor set. In a third variant, the view factor parameters are determined using trained models (e.g., configured to predict the view factor parameter). However, the view factor parameters can be otherwise determined.

The viewshed module functions to determine the regions of visibility (e.g., unobstructed and/or obstructed views) from the location. The viewshed module can include a viewshed algorithm. The viewshed algorithm can create a viewshed by discretizing the 3D regional representation into cells and estimating the difference of elevation from one cell to the next, extending out from the viewpoint's cell. In an example, to determine the visibility of a target cell, each cell between the viewpoint cell and target cell is examined for line of sight. Where cells of higher value (e.g., higher elevation) are between the viewpoint and target cells, the line of sight is blocked. If the line of sight is blocked, then the target cell is determined to not be part of the viewshed. If it is not blocked, then it is included in the viewshed. However, the viewshed algorithm can otherwise determine the viewshed. Examples of viewshed algorithms that can be used include: GIS programs, such as ArcGIS Pro, GRASS GIS (r.los, r.viewshed), QGIS (viewshed plugin), [1] LuciadLightspeed, LuciadMobile, SAGA GIS (Visibility), TNT Mips, ArcMap, Maptitude, ERDAS IMAGINE; and/or any other suitable algorithm or program. The viewshed module can optionally include a viewshed merge module that functions to merge the visible, obstructed, and/or other regions of multiple viewsheds into a single viewshed. In an example, only the visible regions of the viewsheds can be merged; alternatively, both the visible regions and the occlusions of the viewsheds can be merged.

The viewshed module outputs a viewshed for the location, wherein the location viewshed can be determined as a singular viewshed or be constructed by combining viewsheds from multiple viewpoints. The viewshed module preferably determines the location viewshed based on one or more viewpoints and the 3D regional representation, but can additionally or alternatively determine the location viewshed based only on the 3D regional representation, based on other location information (e.g., measurements, descriptions, etc.), and/or any other input.

The overlaying module can function to generate the view factor representation. The overlaying module preferably determines the intersection between the location's viewshed with the view factor set (e.g., view factor map), but can additionally or alternatively determine the view factor segments falling within the location's viewshed, the union of the view factor map and the viewshed, determine the faces of the view factors visible within the viewshed (e.g., by ray tracing the sightlines), and/or otherwise determine the view factor representation.

The view parameter module can function to determine one or more view parameters for a location. The view parameter module preferably determines the view parameter based on the visibility and/or parameters of the view factors within the viewshed (e.g., which view factors are visible, the proportion of the view factors that are visible, the view factor rating for each visible view factor, the contiguity of the visible view factors, etc.), but can additionally or alternatively determine the view factor based on location information (e.g., location measurements, descriptions, etc.), the viewshed and a location measurement, and/or based on any other suitable set of inputs. In a first variant, the view parameter module is an equation or a regression configured to calculate a view metric based on the view factors' ratings and parameters. In a second variant, the view parameter module is a trained model (e.g., neural network) trained to predict the view metric based on location information (e.g., a measurement, such as an aerial image) and optionally a regional view factor set. In this variant, the model can be trained against view metrics that were calculated using the first variant or otherwise determined.

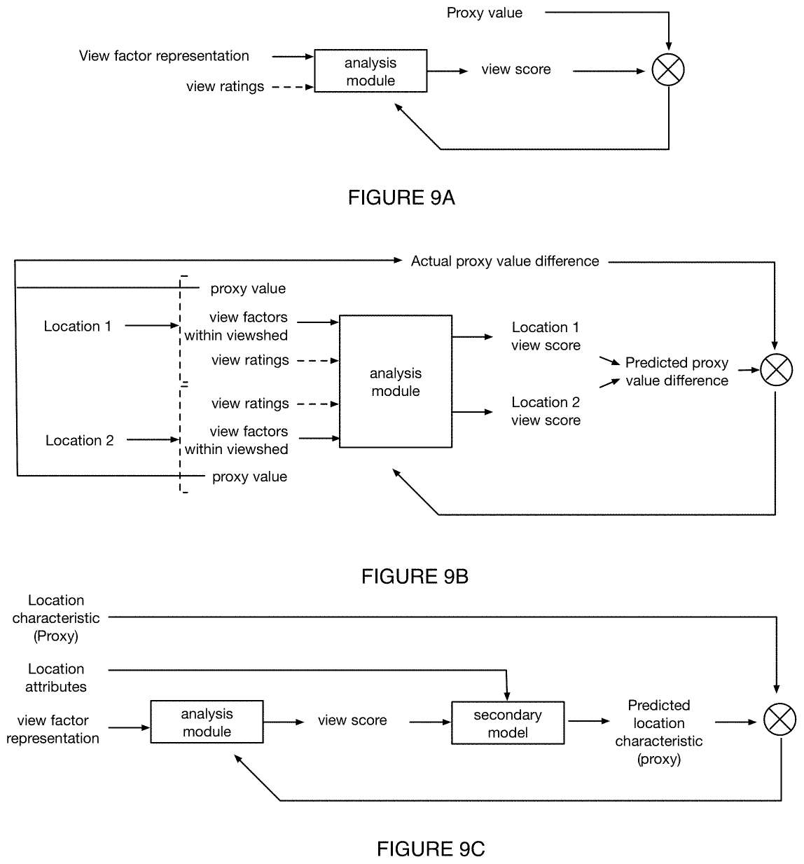

In variants, the view parameter module can be validated or verified against a proxy value. The proxy value is preferably objective, but can alternatively be subjective. The proxy value is preferably quantitative, but can alternatively be qualitative. Examples of proxy values include: property valuations, vacancies, rental values, and/or other proxy values. In a first example, the view parameter module can be validated and/or trained against the error on a predicted property market attribute (e.g., actual vs predicted property valuation), example shown in FIG. 9C. In a specific example, the view parameter module can be validated such that the magnitude of the view metric correlates with the magnitude of the predicted property market attribute's error, and/or the valence of the view metric inversely correlates with the valence of the predicted property market attribute's error (e.g., properties with highly desirable views are expected to have actual values higher than the predicted value; properties with adverse views are expected to have actual values lower than the predicted value; etc.). In a second example, the view parameter module can be validated and/or trained based on the proxy value (e.g., example shown in FIG. 9A). For example, the view parameter module can predict a view metric that is fed into a downstream proxy model that predicts the proxy value (e.g., example shown in FIG. 8B), and the loss on the predicted proxy value can be used to update the view parameter module and/or the downstream proxy model. In a third example, the view parameter module can be validated and/or trained to predict view metrics for test properties that match a manually-determined view desirability ranking between the test properties. In a fourth example, the view parameter module can be validated and/or trained based on the predicted difference between two proxy values that, in turn, were predicted based on the predicted view parameter for two training properties (e.g., example shown in FIG. 9B). However, the view parameter module can be otherwise trained and/or validated.

The location attribute model (e.g., property attribute model) functions to determine a location or property attribute value from a set of location information. The attribute module can be a classifier trained to predict the attribute value from the location information, an object detector, a segmentation module, and/or any other suitable attribute module. In examples, the attribute models can be those described in disclosed in U.S. application Ser. No. 17/529,836 filed on 18 Nov. 2021, U.S. application Ser. No. 17/475,523 filed 15 Sep. 2021, U.S. application Ser. No. 17/749,385 filed 20 May 2022, U.S. application Ser. No. 17/870,279 filed 21 Jul. 2022, and/or U.S. application Ser. No. 17/858,422 filed 6 Jul. 2022, each of which is incorporated in its entirety by this reference. However, any other suitable attribute model can be used.

### 5. Method

As shown in FIG. 1, in variants, a method for viewshed analysis can include: determining a location S100, determining a set of location viewpoints for the location S200, determining a viewshed for the location S300, determining a set of view factors for the location S400, and determining a view factor representation for the location based the viewshed and the set of view factors S500, optionally determining a view parameter for the location S600, and/or any other suitable elements.

The method functions to determine one or more view parameters to describe the view from the location. All data and/or information (and/or a subset thereof) determined by the method processes can be stored in the datastore. All data and/or information (or a subset thereof) used by the method processes can be retrieved from the datastore. Alternatively, the method can receive a location identifier and determine the view parameter on the fly (e.g., not using a datastore).

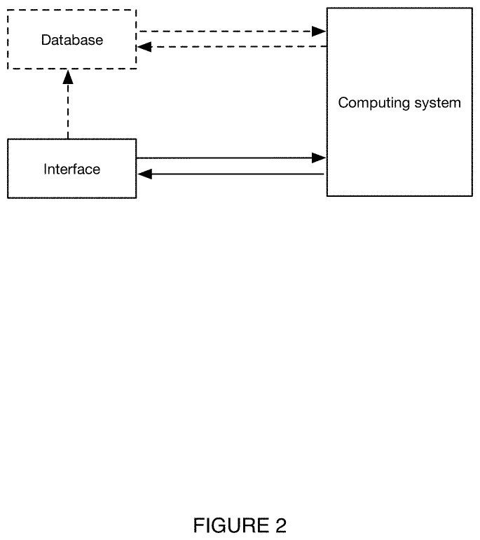

The method can be performed by the system and/or elements discussed above, or be performed by any other suitable system. As shown in FIG. 2, the method can be performed by one or more computing systems, databases, and/or other computing component. Examples of computing systems that can be used include: remote computing systems (e.g., cloud systems), user devices, distributed computing systems, local computing systems, and/or any other computing system. One or more instances of the method can be concurrently or serially performed for one or more locations. In examples, the method can receive inputs from a user through an interface (e.g. GUI) that can communicate with one or more computing systems and databases, and can further render outputs to said interface and/or another endpoint.

All or portions of the method can be performed: in response to receipt of a view parameter request (e.g., from an endpoint); before receipt of a request (e.g., wherein the view parameters or any other parameters for each location can be precomputed); periodically; responsive to occurrence of an event; before a stop condition is met; and/or at any other suitable time.

Determining a location S100 functions to determine which location, or set thereof, to analyze. S100 can determine one or more locations. In a first variant, the location is determined from a request received from an endpoint, wherein the request includes the location identifier. In a second variant, the determined locations include every property (e.g., every primary structure, every parcel, etc.) appearing within a measurement (e.g., an aerial image, a DEM, etc.) and/or a predetermined region (e.g., neighborhood, a geofence, etc.). In a third variant, the determined locations include properties satisfying a predetermined set of conditions. For example, the determined locations can include properties sharing a property class (e.g., single family home, multifamily home, etc.) and geographic region. However, the location or set thereof can be otherwise determined.

The method can optionally include determining a set of view openings for a location S110, which can function to identify and locate possible view openings for a location or a subset of a location. S110 can be performed by the view openings module.

Information pertaining to view openings may be retrieved from building plans, extracted from oblique images of the building, guessed based on the building height & heuristics (e.g., based on the height of the floor and the average height of a human), or determined by any other suitable means. In one embodiment, the view openings module classifies location features as view openings based on imagery (e.g., exterior, interior), descriptions, or other measurements, and outputs information pertaining to each view opening. Optionally the identification method and type of information output may vary by view opening type.

In a preferred embodiment, an algorithm can determine view openings and their locations. Optionally, the method can receive view openings, locations, and dimensions from a source (e.g., a user, a database). In one embodiment, determining a set of view openings comprises accessing location information (e.g., imagery, 2D models, 3D models, descriptions, etc.) and classifying features encompassed by the location as view openings, and determining the features' positions relative to the location. Optionally, S110 may further comprise determining the dimensions, pose, type (e.g., window, balcony, etc.), and any other attributes of the view openings. Optionally, the method can determine location boundaries to be view openings.

Classifying features as view openings from imagery may be based on visual features indicative of view openings (ex. awnings, etc.). In variants, classifying features as view openings may be inferred from text descriptions of a property. Optionally, determining other attributes (e.g., extent, pose, etc.) of a view opening may be similarly inferred from a text description. In variants, object detection models, classification algorithms, or any similar model can be used to identify and locate view openings, and optionally to further determine their orientation.

In variants, additional viewpoints may be determined or otherwise assumed based on heuristics, building codes, or any other property information. Examples of guiding heuristics may include: categorizing any accessible flat roof as a view opening, assuming a building will have a roadside window 3 feet aboveground and offset from a door location.

In variants, the method can be capable of offering a user the option to provide information to identify and locate view openings.

However, the view openings can be otherwise determined.

Determining a set of viewpoints for a location S200 functions to determine where the viewshed should be determined from. In variants, the viewpoint set (and/or summary information thereof) can be used to determine the viewshed, returned responsive to the request, provided to a downstream model, and/or otherwise used. S200 is preferably performed by the viewpoint module, but can be otherwise performed. S200 is preferably determined for the locations determined in S100, but can additionally or alternatively be determined for any other suitable set of locations. The set of viewpoints can include a single viewpoint or multiple viewpoints. S200 can be manually performed, automatically performed, or otherwise determined.

In a first variant, S200 includes receiving a set of viewpoints from the user. This variant can include: presenting a graphical representation of the location (e.g., a map, a geometric model, etc.) to a user, and receiving a set of viewpoints relative to the location from the user (e.g., via a GUI). This variant can additionally or alternatively include receiving text-based and/or numerical viewpoint identifiers (e.g., via a text file).

In a second variant, S200 includes using a set of heuristics. In this variant, the set of viewpoints can be determined based on: location geometry, location boundaries, location view openings, location information, contextual information, or any other suitable source of information.

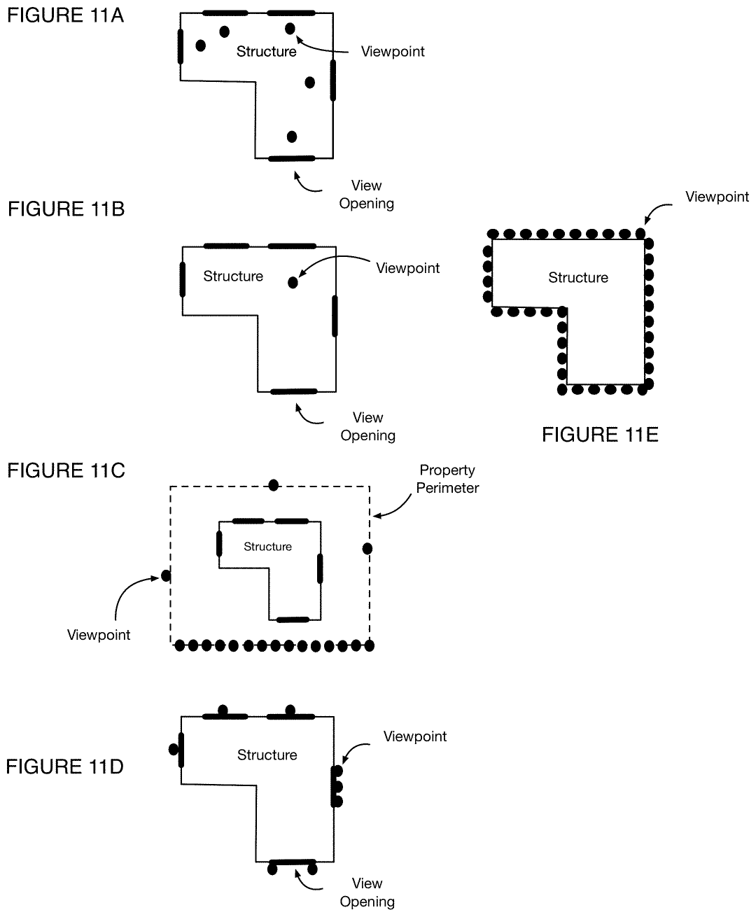

In a first embodiment, the set of viewpoints is determined based on the location's geometry (e.g., wherein the geometry can be retrieved or determined from location measurements). For example, the heuristics can dictate that a viewpoint be placed: at the centroid of a built structure (e.g., example shown in FIG. 11B); at the top level of a structure; at each level of a structure; at a predetermined distance relative to a reference point (e.g., 2 meters below the roof peak, 2 meters below an estimated ceiling, etc.); and/or at any other placement based on the location geometry.

In a second embodiment, the set of viewpoints is determined based on a location's boundary (e.g., retrieved, determining a roof segment from an image, etc.) (e.g., example shown in FIG. 11E). The set of viewpoints can be located: on the boundary itself, recessed a predetermined distance behind the boundary, located a predetermined distance outside of the boundary, and/or otherwise located relative to the boundary. In this embodiment, the set of viewpoints can be determined by: placing viewpoints at boundary corners, uniformly distributing viewpoints along a line or plane of the location boundary, randomly scattering viewpoints along the boundary, or otherwise assigned (e.g., example shown in FIG. 11C). In an illustrative example, the method can include determining a property segment from aerial imagery (e.g., based on parcel data), determining a boundary based on the property segment, and distributing viewpoints along said boundary according to a predetermined heuristic.

In a third embodiment, the set of viewpoints is determined based on a set of view openings of the location. The set of viewpoints can be located: on the view opening itself, offset a predetermined distance from a broad plane of the view opening (e.g., located within a viewing region determined based on the view opening, example shown in FIG. 11A), and/or otherwise located relative to the view opening (e.g., examples shown in FIG. 11D). In a first example, the viewing region includes a predetermined volume (e.g., between 1-10 ft, 2-9 ft, 3-8 ft, etc.) above a horizontal view opening (e.g., a deck). In a second example, the viewing region includes a predetermined volume inside the built structure (e.g., between 0-20 ft, 1-15 ft, 2-10 ft, etc.) behind a vertical view opening (e.g., a window). The set of viewpoints can be: evenly distributed within the viewing region, randomly distributed within the viewing region, unevenly distributed within the viewing region (e.g., with a higher density along the middle of the viewing region, higher density along the sides of the viewing region, higher density proximal the centroid of the view opening, etc.), and/or otherwise determined. The viewpoint distribution and/or assignment heuristic can be determined based on the type of viewpoint, the type of view opening, the type of location, and/or otherwise determined.

In a third variant, S200 includes predicting the viewpoints using a trained viewpoint model. The viewpoints can be predicted based on: imagery of the location (e.g., aerial imagery, oblique imagery, etc.), a 3D representation of the location, a segment thereof, and/or any other suitable input. In this variant, the viewpoint model (e.g., a neural network) can be trained on training data (e.g., imagery, 3D representations, etc.) of the training locations labeled with viewpoints.

However, the viewpoints can be otherwise determined.

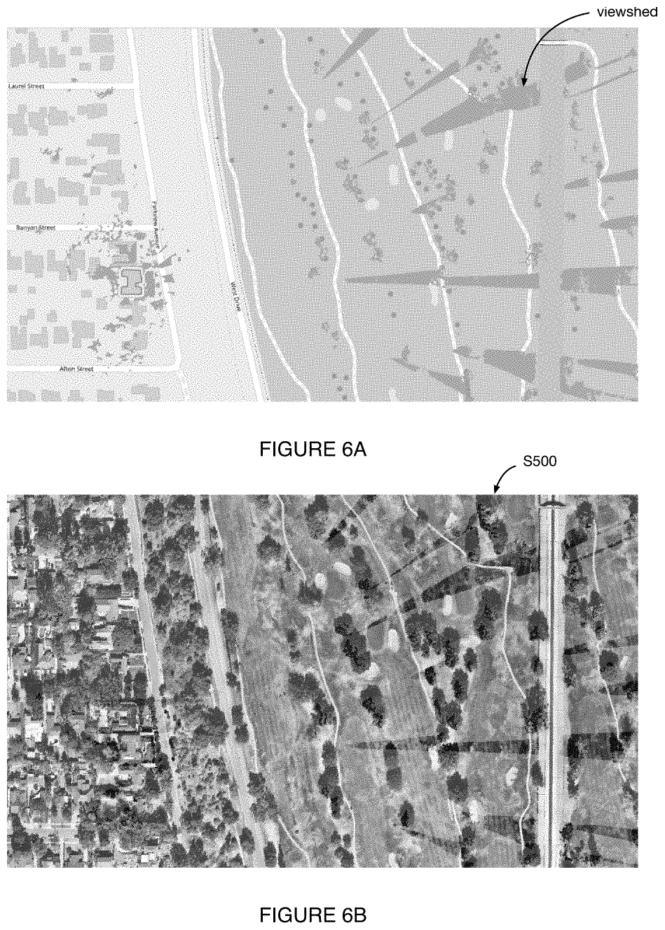

Determining a viewshed for a location S300 functions to determine surrounding regions that are visible from the location (e.g., example shown in FIG. 6A). In variants, the viewshed (and/or summary information thereof) can be used to determine the view factor representation, determine the view metric, returned responsive to the request, provided to a downstream model, and/or otherwise used. S300 can be performed by the viewshed module or by any other suitable module.

The viewshed is preferably determined by a viewshed module (e.g., viewshed algorithm), but can be otherwise determined. The viewshed is preferably determined based on: a set of viewpoints (e.g., determined in S200) and a representation of a region encompassing the location (e.g., a 3D regional representation, land descriptions, an elevation map, 2D imagery, point cloud, etc.), but can additionally or alternatively be determined based on regional measurements (e.g., imagery, 3D regional representation, etc.), location measurements (e.g., same or different from that used to determine the set of viewpoints), the set of view openings, view factor representations, and/or any other suitable information. The viewshed for the location is preferably determined for the entire location (e.g., a combination of one or more viewpoints), but can additionally or alternatively be determined for one or more view openings (e.g., view score for each window in a house), for a subsection or component of a property (e.g., for a single apartment in a building, for one side of a built structure, for one room, for a terrace, for a pool, etc.), for a virtual or hypothetical location or property, for a region (e.g., an entire neighborhood), or for any other suitable location, portions of a location, or combination thereof. In variants, multiple viewsheds can be determined for a location (e.g., one viewshed for each cardinal direction of a built structure, different viewsheds for each floor of a building, different viewsheds for each viewpoint, etc.).

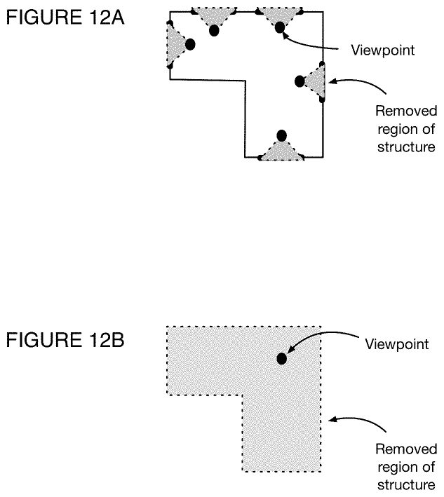

The region representation preferably has the location area removed (e.g., masked out, deleted, zeroed out, etc.), such that the location's structures do not block the viewshed (e.g., example shown in FIG. 12B), but can additionally or alternatively have the view opening regions of a location removed (e.g., example shown in FIG. 12A) and/or have all or other parts of the location area removed. For example, location voxels can be removed from the DEM or DSM used to determine the viewshed. The region representation can be selectively modified to remove the location's structures based on the location's class, always modified, and/or modified when any other suitable condition is met. In a first example, the volume of a primary structure (e.g., a set of points, voxels, etc.) is removed from the 3D representation. In a second example, only the areas (e.g., volumes, voxels, points, etc.) associated with a unit (e.g., apartment or condo) are removed from the 3D representation, while the areas associated with the other units remain intact. However, any other suitable region representation can be used.

In a first variant, the viewshed for the location is determined based on a single viewpoint. The single viewpoint can be: the centroid of the location, a mean or median point determined from the location's boundary, a point determined from a primary view opening (e.g., the largest window of a common living space), and/or be any other suitable viewpoint. In embodiments, this can be repeated for each viewpoint of the location, such that multiple viewsheds (e.g., a different viewshed for each viewpoint or set thereof) can be generated and/or returned.

In a second variant, the viewshed for the location is determined based on a set of viewpoints (e.g., multiple viewpoints). In a first example, the viewshed can be determined for each of a set of viewpoints defined along the location boundary. In a second example, the viewshed can be determined for each of a set of viewpoints defined along the location's view openings. However, the set of viewpoints can be otherwise defined.

In a first embodiment of the second variant, determining the viewshed for the location can include determining a viewshed for each viewpoint (e.g., each viewpoint determined in S200), and merging each of these individual viewsheds into a viewshed for the location (e.g., location viewshed).

The viewshed for each viewpoint (e.g., viewpoint viewshed) can be determined based on the viewpoint and the same or different regional representation (e.g., 3D regional representation), using the same or different instance of the viewpoint module.

Merging the individual viewsheds into a viewshed for the location functions to combine the total areas of each viewpoint's viewshed. The individual viewsheds can be merged: vertically, laterally, and/or along any other suitable dimension. Additionally or alternatively, the viewsheds can remain unmerged, such that different viewsheds are returned, or subsets of viewsheds can be merged (e.g., all viewsheds from the same side of a location are merged).

In a first embodiment, the visible portions (e.g., visible segments) of the viewpoint viewsheds can be merged. For example, the visible regions of each viewpoint viewshed can be joined (e.g., such that nonoverlapping regions of one viewpoint viewshed are added to another viewpoint viewshed). In another example, the visible regions of each viewpoint viewshed can be intersected (e.g., such that nonoverlapping regions of one viewpoint viewshed do not appear in the resultant location viewshed). However, the visible portions can be otherwise merged.

In a second embodiment, the sightlines of the viewpoint viewsheds can be merged. In one example, merging the sightlines can include retaining an extrema sightline in each direction (e.g., the longest sightline in a direction, the shortest sightline in a direction, etc.). In a second example, merging the sightlines can include determining an intermediary sightline for each direction (e.g., averaging the sightlines in each direction, etc.). However, the sightlines can be otherwise merged.

In a third embodiment, the obstructed portions can be merged. For example, the obstructed regions of each viewpoint viewshed can be intersected, joined, unioned, and/or otherwise merged.

In a fourth embodiment, both the obstructed and visible portions can be merged.

In a fifth embodiment, the viewpoint viewsheds can be merged using a voting mechanism. In variants, this can reduce location viewshed noise (e.g., not account for a view seen out of a single window; not account for a view seen out of a small porthole, etc.). In a first example, this can include determining the number of viewpoint viewsheds (e.g., number of votes) that each regional point, segment, or voxel appears in, and including regional points, segments, or voxels appearing in more than a threshold number of viewpoint viewsheds within the location viewshed. The threshold number can be predetermined (e.g., manually assigned, based on a noise threshold, etc.), determined based on the overall number of viewpoints and/or viewpoint viewsheds, and/or otherwise determined. In a second example, this embodiment can include weighting each viewpoint viewshed segment based on a viewshed parameter, such as the overall viewshed area, the viewshed segment's area, the viewshed segment's contiguity, the viewshed segment's dimensions (e.g., depth, width, etc.), the viewshed segment's slope, and/or any other viewshed parameter value (e.g., normalized or unnormalized).

However, the location viewshed can be otherwise determined from a set of viewpoints.

In a third variant, the viewshed for the location is precomputed and retrieved.

In a fourth variant, the viewshed for the location is predicted using a viewshed model (e.g., a neural network) that is trained to predict the location viewshed based on location information. In a first embodiment, the viewshed model predicts the viewshed (e.g., which surrounding regions are or are not visible from the location) based on a 2D image depicting the location and surrounding region. In a second embodiment, the viewshed model predicts the viewshed based on a 3D regional representation (e.g., DSM, DEM, etc.) encompassing the location (e.g., including or excluding the location). In a third embodiment, the viewshed model predicts the viewshed based on a georeferenced 2D image depicting the location, optionally a parcel boundary, and a 3D regional representation of the region surrounding the location. However, the viewshed model can predict the viewshed based on any other suitable set of location information and/or location inputs. The viewshed model can be trained to predict a predetermined viewshed (e.g., determined using a prior variant) for each of a set of training locations based on location information (e.g., a 2D image, 3D regional representation, etc.) for the respective training location.

However, the viewshed can be otherwise determined.

In some variants, S300 can include determining alternative or hypothetical viewsheds for location changes (e.g., for remodeling, upgrades, location changes, etc.). In these variants, determining the hypothetical viewshed can include: determining the location attributes (e.g., view openings, obstructions, property components, etc.), modifying the location attributes, determining a modified set of viewpoints based on the modified location attributes, and determining a viewshed based on the modified set of viewpoints. However, the hypothetical viewshed can be otherwise determined. Modifying the location attributes can include: adding, removing, enlarging, shrinking, moving (e.g., vertically, laterally, etc.), reorienting, and/or otherwise modifying a location attribute. Examples of modifying the location attributes can include: adding or removing the entire location, adding or removing a portion of the location, adding or removing a built structure (e.g. a building), adding or removing a portion of a built structure (e.g., the space between a viewpoint and the boundary of a window), adding or removing a vegetation or a water feature (e.g., a bush, pool, pond, etc.), adding or removing a view opening, adding or removing an obstruction, and/or otherwise modifying any other physical or virtual attribute from the representation (e.g., 3D map) of the region encompassing the location. Alternatively, any such attributes may be added to the region representation (e.g., 3D region representation).

However, the viewshed can be otherwise determined.

The method can include determining a set of view factors for the location S400 (e.g., within a region surrounding the location). The set of view factors can be determined: responsive to receipt of the request, after S100, during S200 and/or S300, asynchronously from S100, S200, and/or S300, before S500, and/or at any other time. The set of view factors can be determined by the view factors module or otherwise determined. The set of view factors can include, for each view factor within the set: the view factor identity, the view factor type, the view factor parameters, and/or any other suitable view factor data.

In a first variant, the set of view factors associated with the location is retrieved from a database (e.g., a third party database, etc.).

In a second variant, the location's view factor set can be determined from the location information using a set of view factor models. The location information can be the same or different from the location information used in S200 and/or S300. The view factor models can be the same or different from the property attribute models. Examples of view factor models can include: building detectors, vegetation detectors, and/or any other suitable set of detectors. In a first embodiment, the view factor set is determined from a set of location images, wherein the set of location images depict a region surrounding the location. In this embodiment, the view factor set is extracted from the set of location images by a set of view factor models (e.g., object detectors, segmentation algorithms), each trained to detect one or more view factors within one or more location images. In a second embodiment, the view factor set is determined from a 3D representation of the region by a set of view factor models (e.g., segmentation algorithms, object detectors, shape matching algorithms, etc.). In a second embodiment, the view factor set is determined from a description of the region by a set of view factor models (e.g., NLP model, etc.).

However, the location's view factor set can be otherwise determined based on the location information.

Determining the location's view factor set can additionally or alternatively include determining one or more view factor parameters (e.g., ratings) for each view factor. In a first variant, determining the view factor parameter for a view factor includes looking up the view factor parameter based on the view factor's identifier and/or type. In a second variant, the view factor parameter for a view factor is determined manually. In a third variant, the view factor parameter for a view factor is calculated based on the attributes (e.g., condition attributes, etc.) for the view factor, wherein the attributes are extracted from a measurement (e.g., image, 3D representation, etc.) or a description of the view factor. For example, the view factor rating for a mansion view factor can be high or have a positive valence, while the view factor rating for an abandoned house can be low or have a negative valence. In a fourth variant, the view factor parameter is determined using a set of predetermined heuristics. However, the view factor parameter for each view factor can be otherwise determined.

Determining a view factor representation for a location S500 functions to generate a representation of what is visible within the viewshed (e.g., example shown in FIG. 6B). In variants, the view factor representation (and/or summary information thereof) can be used to determine the view metric, returned responsive to the request, provided to a downstream model, and/or otherwise used. S500 is preferably performed after the location viewshed and the view factor set are determined for a location, but can additionally or alternatively be performed independent of viewshed and/or view factor set determination, be performed after location information determination, and/or be performed at any other time. S500 can be performed one or more times for a given location (e.g., at different times throughout the year, updated for different hypothetical viewsheds). S500 can be performed by the overlaying module, but can additionally or alternatively be performed by any other suitable system.

The view factor representation is preferably determined based on the set of view factors and the viewshed for the location, but can additionally or alternatively be determined based on: the location measurements (e.g., images depicting the location, images sampled from the location, 3D measurements of the location, etc.), location descriptions, and/or any other suitable information. The view factor representation can be determined using a 2D map of the view factors, the geographic locations for the view factors, a 3D model of the view factors, and/or using any other suitable representation of the view factors.

The view factor representation can be determined: using a mathematical operation (e.g., intersection, union, join, etc.), predicting the view factor representation, manually, and/or otherwise determining the view factor representation.

In a first variant, determining a view factor representation can include determining a union (e.g., intersection, overlap, etc.) between a view factor set (e.g., view factor map) and the viewshed for the location, wherein view factors falling within the location's viewshed are included in the view factor representation. In a first embodiment, the view factor's identifier or the entire view factor falling within the viewshed is included in the view factor representation. In a second embodiment, only a segment of the view factor is included in the view factor representation, and/or segments of each view factor outside of the viewshed are excluded from the view factor representation.

In a second embodiment, determining the view factor representation can include identifying the geographic identifiers for geographic units within the viewshed (e.g., geolocations, voxel identifiers, etc.), then identifying the view factors and/or segments thereof that are associated with (e.g., encompassing) those geographic identifiers.

In a third variant, determining the view factor representation can include identifying the segments of each view factor within the view factor set that intersect sightlines extending from each of the set of viewpoints. In this variant, the identified view factor segments can have a vertical dimension (e.g., nonzero vertical dimension). In an example, the resultant view factor representation can include a set of vertical segments of each view factor, representing the face of each view factor that is visible from the location. In a first illustrative example, the view factor representation can include a set of vertical view factor slices (e.g., depicting the portion of the view factor seen from the location). In a second illustrative example, the view factor representation can include a set of 3D segments of the visible regions of the view factors (e.g., truncated view factors).

In a fourth variant, the view factor representation can be predicted using a trained model (e.g., view factor representation model, VFR model, etc.). In a first embodiment, the VFR model can be trained to predict the view factor representation based on location measurements (e.g., imagery, 3D representation, etc.). In this embodiment, the VFR model can implicitly determine the location viewshed and the view factor set from the location measurements. In a second embodiment, the VFR model can be trained to predict the view factor representation based on location measurements and a set of view factors. In this embodiment, the VFR model can implicitly determine the location viewshed from the location measurements. In a fourth embodiment, the VFR model can be trained to predict the view factor representation based on the location's viewpoints (e.g., from S200) and/or the location viewshed (e.g., from S300) and a location measurement. In a fifth embodiment, the VFR model can be trained to predict the view factor representation based on the location's viewpoints (e.g., from S200) and/or the location viewshed (e.g., from S300) and a view factor set. However, the VFR model can predict the view factor representation based on any other set of inputs.

In a fifth example, the view factor representation may be computed from (or the viewshed analysis may be supplemented by) imagery taken from within the bounds of the property (e.g., from interior imagery depicting a view out a window). For example, the view factor representation of a structure may be extracted from analysis of imagery taken inside each of the windows of the structure. In this example, S500 can include: optionally identifying a segment of the measurement depicting the environment outside of the location; optionally determining a sampling pose (e.g., which segment of the environment is being shown); identifying the view factors and/or segments thereof within the measurement segment (e.g., using a set of view factor models); and matching the identified view factors with known view factors from the view factor set.

However, the view factor representation can be otherwise determined.

In variants, S500 can optionally include determining view factor parameters and/or view factor attributes for each view factor within the view factor representation. The view factor parameters and/or view factor attributes for each view factor within the view factor representation can be determined by: retrieval, calculation, prediction, and/or otherwise determined. In a first example, this can include determining the view factor rating (e.g., by retrieving the view factor rating). In a second example, this can include determining the view factor's contiguity (e.g., by determining how contiguous the view factor's segment is within the view factor representation). In a third example, this can include determining the proportion of the view factor within the view factor representation (e.g., by comparing the view factor segment falling within the viewshed with the overall area for the view factor). In a fourth example, this can include determining the proportion of the view occupied by the view factor (e.g., by calculating the view factor's segment area relative to the overall viewshed area). However, the view factor parameters and/or attributes can be otherwise determined.

In variants, S500 can optionally include determining summary data for the view factor representation (VFR). Summary data can include: the number of view factors within the VFR, the density of view factors within each zone of the VFR (e.g., within a first distance, a second distance, etc.), the contiguity of the set of visible view factors (e.g., within the VFR, such as the average contiguity of the visible view factors, etc.), the distance between a view factor and the location, and/or any other suitable metric summarizing the attributes of the visible view factor population within the VFR.

However, S500 can be otherwise performed.

The method can optionally include determining a view parameter for the location based on the view factor representation S600, which functions to translate the view factor representation into an objective metric. In variants, the view parameter can be used to determine the impact of the position and/or orientation of location changes (e.g., window placement, tree removal, etc.), used to estimate a property market attribute (e.g., property valuation, valuation error, rent error, rent value, vacancy, etc.), used to compare different properties (e.g., from the same or different geographic region), and/or otherwise used. For example, determining a view metric on a scale of 0 to 10 for multiple properties enables comparison of the views from each of these properties. S600 can be performed by the view parameter module.

View parameters can be determined for: the location, for one or more view openings (e.g., view score for each window in a house), for a subsection or component of a property (e.g., for a single apartment in a building, for one side of a built structure, for one room, for a terrace, for a pool, etc.), for a virtual or hypothetical location or property, for a region (e.g., an entire neighborhood), or for any other suitable location, portions of a location, or combination thereof.

The view parameter for the location can be determined based on the view factor representation for one or more locations.

In a first variant, the view parameters are determined based on the view factors (e.g., view factor identity) within the view factor representation.

In a second variant, the view parameters are determined based on the view factor parameters for each view factor within the view factor representation (e.g., view factor ratings, contiguity of view, total viewshed area, percentage of viewshed area occupied by each view factor, categorizations of natural vs built, building character, total sky viewshed area, percentage positive vs negative view factors in viewshed, etc.). For example, the view rating for each view factor can be scaled, normalized, or otherwise adjusted by the respective view factor area appearing in the viewshed footprint. In a specific example, a view metric can be calculated (e.g., using a weighted sum, regression, etc.) based on the area or volume of each view factor within the view factor representation and the view rating (e.g., valence, beneficial/neutral/adverse classification, example shown in FIG. 7B, etc.). In an illustrative example, view parameters can be determined using an equation or heuristic (e.g., regression, view score=sum of [visible view factor rating]*[% of viewshed occupied by view factor] for all view factors, example shown in FIG. 7A, etc.).

In a third variant, the view parameter is predicted by a trained model (e.g., neural network). In a first embodiment, the model predicts the view parameter value based on a location measurement or description. In a second embodiment, the model predicts the view parameter value based on location information (e.g., measurement, description, etc.) and a view factor set associated with the location. In a third embodiment, the model predicts the view parameter value based on a view factor representation (e.g., example shown in FIG. 9A). However, the view parameter can be predicted based on any other suitable set of inputs.

In this variant, the model can be trained to predict the view parameter value, determined using another variant, based on the respective input data. Additionally or alternatively, the model can be trained based on a proxy value (e.g., external metric), such as the property valuation, rental value, vacancy, and/or other proxy attribute; the proxy prediction error (e.g., calculated between a predicted proxy value and the actual proxy value); and/or otherwise trained. In a first example, the model can be trained by predicting the view parameter (e.g., view metric) for a training property, predicting the valuation for the training property based on the view parameter, determining the valuation error for the training property, and updating the model based on the error (e.g., to maximize the error, to minimize the error, etc.) (e.g., illustrative example shown in FIG. 9C). In a second example, the model can be trained by predicting the view parameters for similar properties with different views, determining an actual proxy value difference between the properties (e.g., actual valuation difference), and training the model based on the difference (e.g., to maximize the difference, minimize the difference, be predictive of or correlated with the difference, etc.) (e.g., illustrative example shown in FIG. 9B).

In variants, the location's view parameters (e.g., view parameter for the location) are determined relative to other locations' view parameters (e.g., view parameters for the other locations). For example, a location's view score can be determined relative to a set of reference properties' view scores. In an illustrative example, the location's view score can be normalized based on neighboring properties' view scores. In a second illustrative example, the location's view score can be determined to be above or below the reference properties' average, a multiple of the 1.5× reference properties' average, and/or otherwise ranked relative to the reference properties.

However, the view parameter can be otherwise determined.

### 6. Use Cases

All or portions of the methods described above can be used for automated property valuation, for insurance purposes, for telecommunication purposes, be returned responsive to the request, and/or otherwise used. For example, any of the outputs discussed above (e.g., one or more view parameters) can be provided to an automated valuation model (AVM), which can predict a property value based on one or more of the attribute values (e.g., feature values), generated by the one or more models discussed above, and/or attribute value-associated information. The AVM can be: retrieved from a database, determined dynamically, and/or otherwise determined. The AVM can be further used to identify underpriced properties, identify potential areas for repairs or renovations, establish an offer price, supplement a property-level valuation report, or otherwise used within the real estate field. Similarly, the outputs discussed above can be used to determine: rental value, vacancy, the impact of upgrades or location changes (e.g., window placement, terrace placement, tree addition or removal, etc.), renovation cost, the error of any of the aforementioned (e.g., valuation error, rent error, etc.), a correction for the errors, and/or any other suitable property attribute (e.g., property market attribute). In an example, value metrics can be determined for a current property and for a set of hypothetical property adjustments (e.g., with adjusted view openings, obstructions, etc.), wherein the view metric values can be compared to determine which property adjustment would yield the best view. In another example, value metrics can be determined for a current property and a proposed change to the location (e.g., using different instances of the method), wherein an effect of the change can be determined based on a comparison between the view metric values. In another example, any of the outputs discussed above can be provided to a model and used to determine an unobstructed direction from which to broadcast signals to a building and/or receive signals from a building. However, the outputs of the method can be otherwise used.

The method can optionally include determining interpretability and/or explainability of the trained model, wherein the identified attributes (and/or values thereof) can be provided to a user, used to identify errors in the data, used to identify ways of improving the model, and/or otherwise used. Interpretability and/or explainability methods can include: local interpretable model-agnostic explanations (LIME), Shapley Additive explanations (SHAP), Ancors, DeepLift, Layer-Wise Relevance Propagation, contrastive explanations method (CEM), counterfactual explanation, Protodash, Permutation importance (PIMP), L2X, partial dependence plots (PDPs), individual conditional expectation (ICE) plots, accumulated local effect (ALE) plots, Local Interpretable Visual Explanations (LIVE), breakDown, ProfWeight, Supersparse Linear Integer Models (SLIM), generalized additive models with pairwise interactions (GA2Ms), Boolean Rule Column Generation, Generalized Linear Rule Models, Teaching Explanations for Decisions (TED), and/or any other suitable method and/or approach.

All or a portion of the models discussed above can be debiased (e.g., to protect disadvantaged demographic segments against social bias, to ensure fair allocation of resources, etc.), such as by adjusting the training data, adjusting the model itself, adjusting the training methods, and/or otherwise debiased. Methods used to debias the training data and/or model can include: disparate impact testing, data pre-processing techniques (e.g., suppression, massaging the dataset, apply different weights to instances of the dataset), adversarial debiasing, Reject Option based Classification (ROC), Discrimination-Aware Ensemble (DAE), temporal modelling, continuous measurement, converging to an optimal fair allocation, feedback loops, strategic manipulation, regulating conditional probability distribution of disadvantaged sensitive attribute values, decreasing the probability of the favored sensitive attribute values, training a different model for every sensitive attribute value, and/or any other suitable method and/or approach.

Different subsystems and/or modules discussed above can be operated and controlled by the same or different entities. In the latter variants, different subsystems can communicate via: APIs (e.g., using API requests and responses, API keys, etc.), requests, and/or other communication channels.

Different processes and/or elements discussed above can be performed and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A method comprising:
determining a set of view openings for a location;
determining a set of location viewpoints for the location based on the set of view openings;
determining a viewshed for the location based on the set of location viewpoints;
determining a view factor representation for the location based on the viewshed and a view factor map associated with the location, wherein the view factor representation comprises a set of visible view factors within the viewshed; and
determining a view parameter for the location based on the view factor representation.

2. The method of claim 1, wherein the set of view openings are determined based on imagery of the location.

3. The method of claim 1, wherein determining a viewshed for the location comprises:
using a viewshed model to determine a viewpoint viewshed for each of the set of location viewpoints; and
aggregating the viewpoint viewsheds into the viewshed for the location.

4. The method of claim 3, wherein the viewpoint viewsheds for each location viewpoint are determined by
determining a 3D representation associated with the location;
removing areas of the location from the 3D representation; and
determining a viewpoint viewshed for each location viewpoint based on a resultant 3D representation.

5. The method of claim 1, wherein determining the view factor representation for the location comprises determining an intersection between the viewshed and the view factor map.

6. The method of claim 5, wherein the view factor map is determined based on imagery of a region encompassing the location.

7. The method of claim 1, further comprising determining an effect of a change to the location, comprising:
determining a hypothetical viewshed based on the change;
determining an updated view factor representation based on the hypothetical viewshed;
determining a hypothetical view parameter based on the updated view factor representation; and
determining the effect based on a comparison between the view parameter and the hypothetical view parameter.

8. The method of claim 1, further comprising determining a built structure segment for the location, wherein the set of location viewpoints are determined based on the built structure segment.

9. The method of claim 8, further comprising:
determining an image for the location;
determining parcel data for the location; and
determining the built structure segment for the location based on the image and the parcel data.

10. The method of claim 1, further comprising determining a property valuation based on the view parameter.

11. The method of claim 1, wherein the set of location viewpoints are determined based on a pose of each of the set of view openings, wherein the set of view openings are determined based on location information.

12. A method, comprising:
determining a location of interest;
determining location information, comprising location imagery, for the location of interest;
determining a set of view factors associated with the location of interest; and
determining a view score, indicative of view factors from the set of view factors that are visible within a viewshed of the location of interest, based on the location information and the set of view factors.

13. The method of claim 12, wherein determining the view score comprises predicting the view score based on the location information using a trained model.

14. The method of claim 13 wherein the trained model is trained on training location information and a set of training view scores for each of a set of training locations, wherein the set of training view scores for each training location is determined by:
determining a viewshed for the training location based on the training location information;
determining a training view factor set associated with the training location;
determining a set of visible view factors for the training location based on the respective viewshed and the respective training view factor set; and
calculating the set of training view scores based on the set of visible view factors for the training location.

15. The method of claim 12, wherein the view score is determined based on a parameter of the view factors visible within the viewshed.

16. The method of claim 15, wherein the parameter comprises at least one of: a percentage of each view factor visible within the viewshed, a contiguity of each view factor visible within the viewshed, or a class of each view factor visible within the viewshed.

17. The method of claim 12, further comprising determining a viewshed for the location of interest, comprising:
determining a boundary for the location of interest based on an image of the location;
determining a plurality of location viewpoints based on the boundary;
computing a viewpoint viewshed for each of the location viewpoints; and
aggregating the viewpoint viewsheds into the viewshed for the location.

18. The method of claim 12, further comprising determining the viewshed, comprising:
determining a 3D representation of a region encompassing the location of interest;
determining a modified 3D representation by removing a section of a built structure of the location of interest from the 3D representation; and
determining the viewshed based on the modified 3D representation and a set of viewpoints for the location of interest.

19. The method of claim 12, wherein determining the view score comprises:
determining a set of visible view factors by intersecting the set of view factors with a viewshed for the location of interest; and
calculating the view score based on the set of visible view factors.

20. The method of claim 12, further comprising:
determining a parcel corresponding to the location of interest;
determining a primary building within the parcel;
determining a boundary based on the primary building; and
determining the viewshed for the location based on the boundary.
